(19) United States
(12) Patent Application Publication
(10) Pub. No.: US 2025/0190952 A1
(43) Pub. Date: Jun. 12, 2025

(54) MACHINE LEARNING-BASED DAMAGE ESTIMATE AND REPAIR ENTITY EVALUATIONS

(71) Applicant: State Farm Mutual Automobile Insurance Company, Bloomington, IL (US)

(72) Inventors: Jaclyn Byers, Normal, IL (US); Amy Davidson, Scootsdale, AZ (US); Kristen Fornnarino Tscholl, New Albany, OH (US)

(21) Appl. No.: 18/672,555

(22) Filed: May 23, 2024

Related U.S. Application Data
(60) Provisional application No. 63/608,745, filed on Dec. 11, 2023.

(51) Int. Cl. G06Q 10/20; G06T 7/00; G07C 5/08

(52) U.S. Cl. CPC G06Q 10/20; G06T 7/0002; G07C 5/0808; G06T 2207/30248

(57) ABSTRACT

Techniques described herein relate to training, deploying, and executing machine learning models to evaluate damage estimates received from repair entities. In various examples, machine learning models may be trained based on damage estimate data, associated vehicle damage data, vehicle specifications, and repair entity attributes. Trained estimate evaluation models may be used to predict damage estimate repair costs, parts and services lists, etc., and/or to score damage estimates for accuracy and competitiveness, and the like. Damage estimate scores can be based on and/or used to determine the accuracy and competitiveness scores for the repair entities that generated the estimates. Estimate evaluation systems may use damage estimate scores and/or entity scores to automatically initiate damage repairs, identify errors/inconsistencies within estimates and request updated versions, and/or identify outlier estimates for additional downstream analysis.

### RELATED APPLICATIONS

This application claims priority to and is a non-provisional of U.S. Patent Application No. 63/608,745, filed Dec. 11, 2023, and entitled “MACHINE LEARNING TECHNIQUES FOR EVALUATION OF RECORDS AND ENTITIES,” the disclosure of which is incorporated by reference herein in its entirety for all purposes.

### TECHNICAL FIELD

The present disclosure relates to machine learning-based techniques for evaluating vehicle damage estimates received from repair entities. In particular, the present disclosure describes techniques for training, deploying, and executing machine learning models to score estimates based on multimodal vehicle damage data, vehicle specifications, repair entity attribute data, and the like.

### BACKGROUND

Damage repair estimates for vehicles may be generated by repair entities (e.g., automobile repair shops and facilities, body shops, mechanics shops, etc.) following vehicle accidents, natural disasters, and/or other incidents causing damage to a vehicle. Damage repair estimates (or damage estimates) may include listings of parts, services, and/or costs associated with the potential repairs to be performed on one or more vehicles. Damage estimates are often critical records that may be relied on by various entities and/or downstream systems to determine the best course of action with respect to a damaged vehicle or other associated entities. For instance, damage estimates may be used by law enforcement organizations, medical providers, insurance entities, and the like, to analyze the cause and extent of the damage to a vehicle, to determine fault and liability, etc. In some cases, damage estimates can be used to determine whether or not a vehicle should be repaired or should be considered a total loss. When determining that a vehicle should be repaired, damage estimates also may be relied on when deciding which repairs should be performed and which repair entity should be selected to perform the repairs. In some cases, damage estimates may be obtained from multiple repair entities, and may be compared and evaluated to determine the optimal repairs and to select the optimal repair entity to repair the vehicle damage.

However, the quality, accuracy, and reliability of damage estimates often vary significantly, and reliance on low-quality or inaccurate estimates can be costly. For example, damage estimates may vary based on the type and extent of the vehicle damage, the specifications and driving history of the particular vehicle, the current cost and availability of parts and labor services, and the repair entity providing the estimate. In some cases, repair entities may provide estimates without having complete information about the extent of the vehicle damage, the history of the vehicle, the current costs of parts/services needed to repair the vehicle, etc. Additionally, damage estimates may vary based on geographic factors associated with the vehicle, owner, and/or repair entity (e.g., which may affect taxes, fees, etc.), as well as towing and/or storage costs that may be outside the control of the repair entity. Different repair entities often may provide different types of information within their damage estimates, and/or may base their estimates on different assumptions regarding the necessary vehicle repairs. For instance, different repair entities may review the same vehicle damage data but may reach different conclusions regarding which vehicle parts can be repaired and which need to be replaced. Additionally, some repair entities may use aftermarket parts, while others may use recycled parts, and others may use original equipment manufacturer (OEM) parts, causing further differences in the damage estimate data and costs.

Further, individual repair entities often may provide different versions of a damage estimate at different times. For instance, a repair entity may provide a first estimate based on an initial set of assumptions regarding the extent of the damage to the vehicle, which repair services will be needed, which parts will be replaced, etc. Subsequently, after analyzing the vehicle damage in more detail (and/or after beginning the repairs), the repair entity may reach different conclusions about the necessary parts and services needed to repair to vehicle and may generate an updated damage estimate. Additionally, estimates from certain repair entities (and/or certain versions of estimates) may include towing charges, storage fees, taxes, waste disposal fees, and the like, while other estimates and/or versions might not include any or all of these additional charges.

For these and other reasons, it can be technically challenging (and infeasible in practice) to efficiently evaluate the quality, accuracy, and/or competitiveness of vehicle damage estimates received from repair entities. As noted above, reliance on low-quality and/or inaccurate estimates can result in incorrect determinations of the type and extent of the vehicle damages, incorrect accident fault/liability determinations, and the like. Thus, low-quality and/or inaccurate damage estimates may result in various excess costs and inefficiencies, including unnecessary repair costs, inflated legal/insurance settlement values, improper total loss determinations, excess towing and storage costs, etc. These costs and inefficiencies may occur both when entities and downstream systems rely on low-quality estimates, as well as when such entities/systems delay action because they know that they cannot rely on potentially low-quality or inaccurate estimates.

To attempt to verify estimate quality and avoid the costs of inaccurate estimates, existing techniques include using manual review processes and/or simple heuristic-based tools to attempt to determine whether an estimate is accurate and/or competitive. For instance, certain existing systems may request damage estimates from multiple repair entities and compare the line items and costs within the multiple estimates to attempt to determine the most accurate and/or competitive estimates. However, these systems may fail to take into account the different methodologies used by different repair entities, including the different costs or fees provided by different repair entities their respective estimates, the different information available to each repair entity at the time of their estimates, what assumptions each repair entity is making about the vehicle damage, and/or what types of parts using each repair entity uses for its repairs. As a result, these existing systems often cannot effectively identify the most accurate and/or most competitive estimates, and may even penalize the repair entities that provide the most thorough and accurate estimates.

Other existing systems may attempt to generate or predict estimated repair costs by comparing the vehicle damage details to the repair costs from similar vehicle accidents/damages. For instance, a manual or heuristics-based tool may output an estimated parts listing or repair cost based on a vehicle type, accident type, and impact velocity. However, these systems may fail to take into account the myriad factors that can significantly affect a damage estimate, including the geographic location/region of the accident, the specifications and driving/accident history of the vehicle, and the current prices and availability of parts, labor, equipment, etc. Additionally, because relatively minor differences in the accident details (e.g., a small difference in impact speed or impact location) can result in large differences in the vehicle damage and necessary repairs, these systems often provide inaccurate predictions of estimated repairs and costs. Other existing systems may request estimates only from one or more repair entities considered to be higher quality and reputable. However, even among high-quality repair entities, the accuracy and competitiveness of individual estimates may vary widely. Additionally, these systems may fail to take into account changes (e.g., patterns, trends, etc.) in the performance of repair entities over time, as well as changes in the costs and availability of parts, equipment, services, and the like.

As these examples illustrate, techniques relying on manual review and/or simple heuristic-based evaluations of estimates often fail to adequately determine whether an estimate is accurate, reliable, and/or competitive. For instance, although existing systems may compare estimate costs or compute averages based on previous repairs, these existing systems are incapable of analyzing an estimate to determine the underlying assumptions relied upon by the repair entity when generating the estimate, verifying that the assumptions are reasonable and likely true based on the available damage data, and confirming that the estimate details conform to those assumptions. For instance, existing systems for evaluating estimates may be unable to analyze the estimate in conjunction with the underlying vehicle and damage data to determine whether the damage identified in the estimate is consistent with the known sources of vehicle damage data, whether the estimate is internally consistent and consistent with the vehicle's specifications, current location, and driving history, and whether the estimate takes into account the proper fees, taxes, storage, and towing costs. For at least these reasons, existing systems for estimate evaluation cannot determine estimate quality, accuracy, and/or competitiveness in a way that is efficient and reliable for use by downstream systems and entities.

The example systems and methods described herein may be directed toward mitigating or overcoming one or more of the deficiencies described above.

### SUMMARY

To address these and other problems and deficiencies in existing technologies, this disclosure describes systems and techniques for training, deploying, and executing machine learning models to evaluate damage estimates received from repair entities. The techniques described herein may be implemented as computer systems, computer-implemented methods, non-transitory computer-readable media storing instructions to perform software processes and services, and the like. In various examples, machine learning (ML) models for estimate evaluation may be trained based on damage estimate data, associated vehicle damage data, vehicle specifications, and repair entity attributes. The trained estimate evaluation models may be used to predict damage estimate repair costs, parts and services lists, etc., and/or to score damage estimates for quality, accuracy, competitiveness, and the like. Scores for damage estimates also may be based on, and/or can be used to determine, accuracy and/or competitiveness scores associated with the repair entities that generated the estimates. In various implementations, estimate evaluation systems may use the damage estimate scores and/or entity scores determined using an estimate evaluation model to control various downstream systems or tasks, including automatically initiating vehicle repairs, identifying errors or inconsistencies within estimates, requesting updated estimate versions, and/or identifying outlier estimates for additional downstream analysis.

In some examples, an estimate evaluation ML model may be trained to output one or more score values associated with a damage estimate, based on input data including the damage estimate and corresponding vehicle damage data, vehicle specifications, repair entity attributes, etc. The input data to an estimate evaluation ML model may include various sources/modalities of vehicle damage data, including images of the vehicle damage, telematics data captured by the vehicle during the damage incident, and/or descriptions of the vehicle damage (e.g., text transcriptions, reports, audio descriptions, etc.). Additional input data to the estimate evaluation ML model may include data representing the damage estimate to be evaluated. In some instances, the damage estimate may include an overall estimated repair cost and/or listings of parts and/or services (which may include cost breakdowns for the parts and services). The damage estimate to be evaluated also may include relevant dates and locations of the vehicle repair, indications of expenses, fees and taxes, vehicle towing times and costs, vehicle storage times and costs, as well as version or date of the estimate and/or other data relating to the repair entity that generated the estimate In various examples, estimate evaluation ML models also may be configured and trained to receive various additional inputs, including the current location (e.g., tow yard, repair shop, owner's residence, etc.) and/or current state (e.g., drivable/not drivable) of the vehicle, as well as the vehicle's specifications (e.g., make, model, year, trim, features, etc.), mileage, and/or driving/damage history. Additionally or alternatively, estimate evaluation ML models may be configured and trained to receive attributes associated with the repair entity that provided the estimate, such as current estimate ratings/scores of the repair entity (e.g., estimate accuracy scores, repair competitiveness scores, etc.), whether the repair entity provides towing and/or on-site storage, and/or an estimate profile for the repair entity (e.g., indicating the patterns/practices of the repair entity, which data the repair entity includes in different versions of the estimate, etc.).

Estimate evaluation ML models may be trained using the various techniques described herein to output score values associated with a damage estimate. For example, an evaluation ML model may output an estimate quality score, estimate accuracy score, and/or estimate competitiveness score based on input data representing a damage estimate from a repair entity. An estimate accuracy score may be a numeric score representing a prediction from the model ML of the likely accuracy of the estimate relative to the eventual vehicle repairs. Estimate accuracy scores may include predictions of the accuracy of the overall repair costs, predictions of the accuracy of the parts listings and/or services listings in the estimate, etc. An estimate competitiveness score may be a numeric score representing a prediction from the model ML (e.g., the same or a different ML model) of the likely competitiveness of the estimate relative to estimates received from other repair entities. For example, a competitiveness score may be a number or percentage representing the likelihood that the final estimate (and/or final repair cost) charged by the repair entity is lower than other repair entities serving the same geographic region.

The various techniques described herein may be used to generate one or more scores associated with a damage estimate, including estimate quality scores, estimate accuracy scores, estimate competitiveness scores, etc. The scores may be determined using any number of various scoring systems and/or rating scales, such as score values on a 0.0 (lowest score) to 10.0 (highest score) scale as shown in FIGS. 5A and 5B. Other scoring systems may include determining estimate scores using a 1-100 (or 0-100) scale, using an F to A+ grading scale, or the like. In some instances, the system may determine a passing threshold for damage estimates (e.g., a threshold value within any of the scoring systems described herein) so that estimates can be assigned a binary (e.g., passing or failing) score based on whether they exceed the threshold. In various examples, estimate score values for quality, accuracy, competitiveness, and the like may be determined as raw score values and/or as percentile scores relative to the scores of other estimates evaluated by the system.

As described herein, scores (e.g., indexes) also may be calculated for repair entities, based on the scores for the various estimates generated by each particular repair entity. For instance, a repair entity estimate quality index, estimate accuracy index, and/or estimate competitiveness index may be determined based on the estimate scores of the subset of estimates determined by the repair entity. Repair entity scores and/or indexes may use similar scoring systems as estimates, or may use different scoring systems (e.g., 0.0 to 10.0, 1 to 100, F to A+, etc.). Additionally, repair entity scores can be calculated as individual values (e.g., mean or median score values) or may be calculated as distributions. In some cases, estimate scores may be determined as raw score values (e.g., based on the output of ML models to determine estimate quality, accuracy, competitiveness, etc.), while in other cases estimate scores may be determined (or weighted) with respect to the repair entity that generate the estimate score and/or the version of the estimate. For example, a first relative accuracy score may be determined for an estimate generated by a first repair entity, while a different relative accuracy score may be determined if the same estimate were generated by a different repair entity.

Additionally or alternatively, in various examples, an estimate evaluation ML model (e.g., the same or a different ML model) may be trained to output a predicted total repair cost, predicted listings of parts and/or services that may be required to repair the vehicle, etc. For example, an overall repair cost within a damage estimate (and/or individual itemized repair costs) can be evaluated or scored with respect to a predicted (or expected) overall repair cost (and/or the sum of predicted itemized repair costs) output by a ML model. If the repair cost listed on a damage estimate is relatively close to the predicted/expected repair cost output by the ML model (e.g., 102% of the expected repair cost, 91% of the expected repair cost, etc.), then the damage estimate may receive a higher overall repair cost score. In contrast, if the repair cost listed on a damage estimate is farther away from the predicted/expected repair cost output by the ML model in either direction (e.g., 180% of the expected repair cost, 55% of the expected repair cost, etc.), then the damage estimate may receive a lower repair cost score. Of course, as described herein, even if a damage estimate is relatively close to the overall expected repair cost, that does not necessary mean that the damage estimate is a high-quality estimate or will have a high accuracy score. ML models and/or heuristics used to determine estimate quality and/or accuracy scores may be based on any combination of the various additional factors described herein. Additionally, in some cases, an estimate evaluation ML model may be trained to output the predicted likelihood(s) that a damaged vehicle is repairable or constitutes a total loss, or may be trained to output data identifying specific errors and/or inconsistencies within the damage estimate that can be used as requests for corrections to the repair entity.

In some examples, the estimate evaluation ML models described herein may be trained using unsupervised learning techniques, based on a combination of historical damage estimates, associated vehicle damage data (e.g., including any of the vehicle/damage/repair entity data described herein), and the corresponding historical (e.g., ground truth) vehicle repair data. The ground truth vehicle repair data may include records based on actual vehicle repairs performed by repair entities after damage estimates were generated. A vehicle repair data record may include a repair service receipt indicating the actual parts used and actual services performed on the vehicle during the repair, the actual cost of repair, etc.

When training an estimate evaluation ML model using unsupervised learning techniques, the training data may include repositories of unlabeled damage estimates, vehicle repair records, and/or additional vehicle/damage/repair entity records. In such examples, the training for the estimate evaluation ML model may implement loss functions based on various estimate quality criteria. The criteria for loss functions used the train the ML models May include, but is not limited to, the difference in total cost between a ground truth damage estimate and corresponding vehicle repair record, the difference in parts listings and/or service listings between a ground truth damage estimate and corresponding vehicle repair record, and/or other inconsistencies between the ground truth damage estimate and corresponding vehicle repair record. In some instances, loss functions may determine costs based on internal inconsistencies within a damage estimate, which may apply costs to damage estimates listing services that are incompatible with the parts in the same damage estimate (or vice versa), or damage estimates listing parts/services that are not compatible with the vehicle's specifications and/or driving history. Additionally, loss functions used to train an estimate evaluation ML model may apply weights (e.g., increasing, reducing, or eliminating costs) based on repair entity attributes, for example, to account for different types of information included/excluded in different versions of the estimate, etc.

As described in more detail herein, estimate evaluation ML models may be implemented and trained as multimodal ML models configured to receive input data from different data modalities (e.g., damage estimate input data, vehicle damage input data, repair entity input data, vehicle specifications input data, etc.). For instance, an estimate evaluation ML model may include multiple encoders, trained individually or in combination, to receive and encode input data from the various data modalities. In other examples, estimate evaluation ML models may be implemented as a combination of multiple ML models, which may be trained individually or in combination, working in conjunction to output damage estimate scores based on the multimodal inputs. For instance, an estimate evaluation ML model may include (or may use the output from) one or more separate vehicle damage prediction models. The vehicle damage prediction model(s) may receive input data from one or more types (or modalities) of vehicle damage input data, including vehicle image data, damage descriptions, and/or vehicle telematics data. In some examples, a multimodal vehicle damage prediction model may be used to output a multi-channel vehicle damage map based on the various vehicle damage input data. For instance, the multi-channel vehicle damage map may include a mapping of the vehicle (e.g., including external and/or internal components) identifying damage locations, severities, confidence levels, and/or other data representing the predicted damage to the vehicle. In various examples, multimodal vehicle damage prediction model may include trained sub-models configured to predict vehicle damage based on individual modalities of data (e.g., a separate telematics-based damage prediction model, image-based damage prediction model, description-based damage prediction model, etc.), or may include a single ML model configured to receive any subset of inputs from the different modalities of vehicle damage data.

Estimate evaluation ML models may be deployed and executed in various computing environments, and may be used to analyze and score damage estimates for various downstream tasks and entities. In some examples, an estimate evaluation ML model may be deployed in a cloud-based computing environment (e.g., public cloud, private cloud, and/or hybrid cloud). For instance, an estimate evaluation ML model may be associated with a cloud-based service, and may evaluate estimates in real-time (or near real-time) based on data retrieved from various cloud-based data sources (e.g., vehicle damage data sources, vehicle specification data sources, repair entity profile data sources, etc.). Additionally or alternatively, any or all of these components may be implemented in on-premise data centers or servers, or in other non-cloud computing environments. In such cases, an estimate evaluation ML model may receive damage estimates within the data center computing environment, and retrieve the model input data from various on-premise and/or cloud-based data sources.

In some examples, an evaluation system may be configured to automatically execute an estimate evaluation ML model in response to receiving a damage estimate from an upstream system (e.g., a repair entity system). In such examples, after receiving an indication of a received damage estimate, the evaluation system may retrieve the associated input data for executing the ML model (e.g., vehicle damage data, repair entity data, etc.) and invoke the ML model to score the estimate. In some cases, the evaluation system may be configured to execute the ML model and score the estimate based on certain subsets of the model input data (e.g., when the complete input data is not available). For instance, the evaluation system may execute the ML model to determine a preliminary score(s) for a damage estimate using an associated set of telematics data, even when image data, text descriptions of the accident, and/or other damage data might not be available. However, when additional sources of input data to the ML model are received (e.g., additional images or text descriptions of the damage, current vehicle status/location data, repair entity attributes, etc.), the evaluation system may be configured to automatically re-execute the estimate evaluation ML model with the additional input data, to determine updated score(s) for the damage estimate.

The output of evaluation systems using estimate evaluation ML models, including damage estimate accuracy and/or competitiveness scores, may be used by various downstream systems and/or entities. In some cases, the accuracy and/or competitiveness scores output by an estimate evaluation ML model may be compared to one or more thresholds and used to automatically initiate the vehicle repairs by the repair entity that provided the estimate, or a different repair entity that provided an earlier estimate. In some instances, certain outputs of the estimate evaluation ML model (e.g., an accuracy score below a threshold) may indicate an error or inconsistency within the damage estimate, which may cause the evaluation system to automatically request an updated/corrected estimate from the repair entity. Additionally or alternatively, the accuracy and/or competitiveness scores for a damage estimate may indicate that the estimate is a statistical outlier or anomaly (e.g., for damage estimates generally, for the repair entity, and/or for particular locations, types of damage, etc.). In such cases, the damage estimate can be automatically routed to additional downstream systems and/or processes for further review and analysis of the outlier estimate.

The techniques described herein thus provide various technical advantages in evaluating damage estimates from repair entities, and more generally, in training, deploying, and executing machine learning models in computing environments. Initially, the ML model training techniques described herein provide improved accuracy and efficiency over existing systems for determining whether an estimate received from a repair entity is accurate and/or competitive. Unlike existing systems, the ML-based techniques described herein may learn to reliably predict the level of quality of damage estimates, including by learning the underlying assumptions relied-on by the repair entity when generating the estimate, verifying the reasonableness of the underlying assumptions (e.g., based on the multimodal vehicle damage data), and taking into account repair entity-specific attributes based on profiles. These systems and techniques also provide improved and more efficient operations with respect to obtaining new or updated estimates, automatically analyzing outlier estimates, and/or initiating vehicle repairs. As described herein, these techniques also may improve the functioning and efficiency of computer systems that use ML models within estimate evaluation systems, including using an event-driven system to automatically trigger execution of an estimate evaluation ML model in response to receiving an estimate from a repair entity, automatically executing (or re-executing) the ML model based on receiving updated vehicle damage data from one or more data sources, and/or initiating requests to repair entities for updated or corrected estimates based on the analysis of the ML model.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example estimate evaluation system including input data sources, an estimate evaluation ML model configured to output estimate quality scores, and a damage estimate processor, in accordance with one or more examples of the present disclosure.

FIG. 2 illustrates an example training system configured to train an estimate evaluation ML model based on damage estimate data and corresponding ground truth repair data, in accordance with one or more examples of the present disclosure.

FIG. 3 illustrates an example architecture of a multimodal estimate evaluation machine learning model, in accordance with one or more examples of the present disclosure.

FIGS. 4A and 4B illustrate two example architectures of damage prediction machine learning models, in accordance with one or more examples of the present disclosure.

FIGS. 5A and 5B illustrate two examples of executing an estimate evaluation machine learning model to evaluate damage estimates received from a repair entity, in accordance with one or more examples of the present disclosure.

FIG. 6 shows an example system architecture for a computing device capable of executing program components in implementing various techniques described herein.

FIG. 7 is a flow diagram illustrating an example process for training one or more estimate evaluation machine learning models, in accordance with one or more examples of the present disclosure.

FIG. 8 is a flow diagram illustrating another example process executing an estimate evaluation machine learning model to determine and initiate processes on one or more target systems based on the model output, in accordance with one or more examples of the present disclosure.

### DETAILED DESCRIPTION

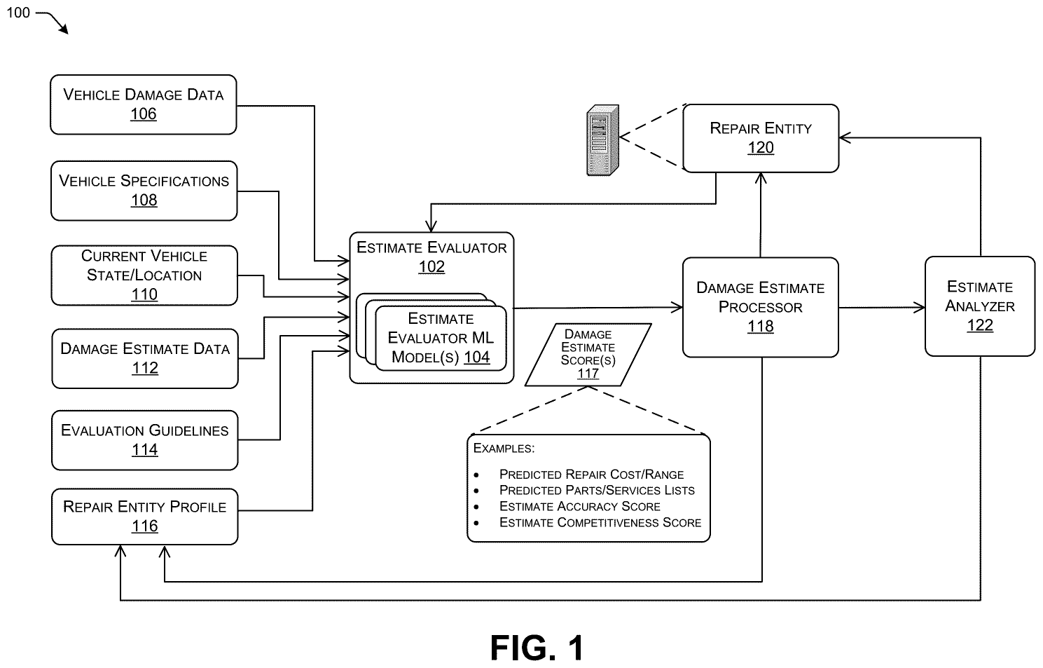

FIG. 1 depicts an example system 100 including an ML-based estimate evaluator 102 configured to execute one or more evaluation machine learning (ML) model(s) 104 to evaluate damage estimates received from repair entities. As described herein, the estimate evaluation ML models 104 may be trained and executed to determine damage estimate scores representing predictions of estimate quality, accuracy, competitiveness, and the like. To evaluate an estimate received from a repair entity, the estimate evaluator 102 may receive inputs based on data from various data sources 106-116. The data sources 106-116 may operate separately and independently from one another, to provide vehicle-related, damage-related, and/or repair entity-related data to the estimate evaluator 102, via over one or more data channels (e.g., communication channels, network protocols, and/or communication networks). In some cases, one or more of the data sources 106-116 may be included within a damage estimate data repository in the system 100. In other cases, any or all of the data sources 106-116 may be implemented as remote and/or independent data services controlled by entities external to the system 100, which are accessed by the system 100 via communication networks.

As described in more detail below, the estimate evaluation ML model(s) 104 may be configured and/or trained to receive various subsets or combinations of data from the data sources 106-116. For instance, in various examples, an estimate evaluation ML model 104 may be trained to receive particular types and/or combinations of vehicle damage data 106, as well as particular types of damage estimate data 112. Additionally, various types of vehicle specifications data 108, current vehicle state and/or location data 110, evaluation guidelines 114, and/or repair entity profile data 116 may be provided as inputs to the estimate evaluation ML model 104 in some examples, or may be excluded or optional in other examples. Evaluation guidelines 114 may include, for example, rules or requirements for a repair entity that will perform the vehicle repairs associated with the estimate, as well as rules or requirements associated with the parts, labor, services, and/or equipment that will be used to repair the vehicle. As an example, an evaluation guideline 114 may indicate whether or not the vehicle repairs are required to be made by a certified dealership or other certified repair entity (e.g., an entity having one or more specific certifications), or whether the vehicle repairs can be made by a direct repair partner without certain certifications, etc. Another examples of an evaluation guideline 114 may include whether or not the vehicle repairs must be made with OEM parts, or can be made with recycled parts, aftermarket parts, etc.

As described above, it may be useful for any number of entities, including accident investigators (e.g., law enforcement, etc.), medical providers, property owners, insurance providers, counterparties to vehicle accidents, etc., to receive quick and accurate information regarding the quality of a damage estimate resulting from a vehicle accident, natural disaster, or other damage incident. However, existing techniques for evaluating the quality, accuracy, and/or competitiveness of estimates may be costly, time-consuming, and error-prone. As a result, the trained estimate evaluation ML model(s) 104 described herein may provide quicker and more efficient determinations of the quality, accuracy, and competitiveness of damage estimates received from repair entities (e.g., automobile repair shops, body shops, mechanics shops, etc.). Based on multiple types (or modalities) of input data, including one or more sources of vehicle damage data 106 (e.g., images of damage, telematics data, accident/damage descriptions, etc.), vehicle specifications data 108, current vehicle state and/or location data 110, evaluation guidelines 114, damage estimate data 112, and various repair entity profile data 116, the trained estimate evaluation ML model(s) 104 may output one or more damage estimate scores 117 associated with the damage estimate data 112. As shown in this example, the damage estimate scores 117 may include predicted costs (or ranges of costs) for repairing the vehicle, predicted listings of parts and/or services for repairing the vehicle, and/or various estimate quality ratings (or scores) such as an estimate accuracy score and estimate competitiveness score.

To receive the various input data from data sources 106-116, the estimate evaluator 102 may include application programming interface (API) layers including one or more APIs associated with each of the independent data sources 106-116. In some examples, multiple estimate evaluation ML models 104 within the estimate evaluator 102 may be configured to receive different sets of input data, including any combination of the various input data described herein (e.g., any data received from data sources 106-116, and/or additional data retrieved from a vehicle repository, accident/damage data repositories, and/or repair entity repositories). In such examples, after receiving and analyzing a damage estimate (and/or after receiving the associated vehicle data, damage data, etc.), the estimate evaluator 102 may select a particular estimate evaluation ML model 104 to be executed based on the attributes of the received estimate. For instance, different ML models 104 may be trained and used to evaluate estimates in different states/geographic regions, based on different accident types (or natural disaster types), within different cost ranges, and/or for different types of vehicles. In these examples, the estimate evaluator 102 may include components to generate and provide specific payloads of estimate-related input data that are compatible with the particular estimate evaluation ML model 104 being invoked to evaluate the damage estimate.

As noted above, the various data sources 106-116 may be implemented as independent computer systems, which may be configured to provide particular types of vehicle data, accident data, repair entity data, and the like to the estimate evaluator 102. Each of the data sources 106-116 may provide different types of damage-related data, vehicle-related data, and/or estimate-related data, which may include unique data or may overlap with the data provided by other data sources. Any of the data sources 106-116 may provide individual transmissions of data to the estimate evaluator 102, or may provide multiple transmissions of data at different times. As discussed below, the estimate evaluator 102 may retrieve estimate-related data from the data sources 106-116 after receiving an initial request, but also may receive subsequent unexpected deliveries of damage-related data, vehicle-related data, estimate-related data, etc., from the data sources 106-116 at any time. Any or all of the components of the system 100, including the data sources 106-116, estimate evaluator 102, damage estimate processor 118, etc., may be cloud-based components implemented within a public cloud, private cloud, and/or hybrid cloud environment. Additionally or alternatively, any or all of these components may be implemented in on-premise data centers or servers, or in other non-cloud computing environments.

In some examples, the estimate evaluator 102 may implement an event-driven system, in which the estimate evaluator 102 initially receives a damage estimate to evaluate (e.g., from a repair entity 120). After receiving the damage estimate to evaluate, the estimate evaluator 102 may retrieve data relevant to the estimate, and/or may subscribe to receive estimate-related data “events” (e.g., transmissions of new or updated estimate-related data) from any or all of the data sources 106-116. In some cases, the estimate evaluator 102 may initially retrieve input data relating to the estimate from the data sources 106-116 and trigger the execution of an estimate evaluation ML model 104 with the initial input data. However, in some instances, due to delays in the data sources 106-116, network/transmission delays, or the unavailability of certain requested input data, the initial set of input data that can be retrieved by the estimate evaluator 102 may be a partial or incomplete set of input data. In some instances, the estimate evaluator 102 may evaluate the set of input data received from the data sources 106-116 (e.g., the types of data, the amounts of data, whether particular critical input data has been received, etc.), in order to determine whether or not to execute the estimate evaluation ML model 104. In these cases, when critical input data and/or a sufficient amount of input data has not been received, the estimate evaluator 102 may delay execution of the estimate evaluation ML model(s) 104 in order to improve compute efficiency. Alternatively, the estimate evaluator 102 may initiate an initial execution of the estimate evaluation ML model 104 based on partial or incomplete data, in which case the estimate evaluation ML model(s) 104 may be trained to predict damage estimate scores 117 based on various subsets of partial input data.

In some examples, the estimate evaluator 102 also may be configured to perform subsequent executions of the estimate evaluation ML model(s) 104, in response to receiving updated estimate versions, and/or in response to receiving updated or additional data from the data sources 106-116. For instance, after receiving a first version of an estimate from a repair entity 120, the estimate evaluator 102 may retrieve data from data sources 106-116 and perform an initial execution of estimate evaluation ML model(s) 104 to generate a first set of damage estimate scores 117. Subsequently, if additional data becomes available from the data sources 106-116 (e.g., additional images of the damage, additional telematics data, additional accident description data, updated vehicle state data, etc.), the estimate evaluator 102 may analyze the additional data to determine whether or not to perform another execution of estimate evaluation ML model(s) 104 to generate an updated set of damage estimate scores 117. In some cases, estimate evaluator 102 may use thresholds on the types and amounts of new data received from the data sources 106-116, to determine whether or not to re-execute the estimate evaluation ML model(s) 104. Additionally, if the repair entity 120 provides an updated version of the damage estimate, the estimate evaluator 102 may (if needed) retrieve updated data from data sources 106-116 based on the updated estimate version, and perform another execution of estimate evaluation ML model(s) 104 to generate updated damage estimate scores 117 based on the updated estimate.

In various examples, the estimate evaluator 102 may receive damage estimates to evaluate directly from a repair entity 120, as an input from the damage estimate data 112, and/or from other upstream systems configured to use the estimate evaluator 102 to generate damage estimate scores 117. When the estimate evaluator 102 receives a damage estimate to evaluate from a repair entity 120 or other source, the estimate evaluator 102 may initially analyze the damage estimate (e.g., using vehicle identifiers, owner names, entity names, times, locations, etc.) to determine the vehicle associated with the estimate, the accident (or other damage incident), and the repair entity that generated the estimate. The estimate evaluator 102 may then retrieve data associated with the vehicle, the accident/damage incident, the repair entity, and/or any other estimate-related data from the various data sources 106-116. The data sources 106-116 may provide data to the estimate evaluator 102 in response to requests (e.g., a web-based request or web services request), or proactively using an event-driven architecture in which the estimate evaluator 102 subscribes to receive particular types of data events from the data sources 106-116. The estimate evaluator 102 may then generate an input data payload (e.g., by analyzing, combining, and/or formatting the input data received from the data sources 106-116), and use the input data payload to execute one or more estimate evaluation ML models 104 to determine the damage estimate scores 117 for the damage estimate. As noted above, the estimate evaluator 102 may execute and re-execute estimate evaluation ML models 104 multiple times as new/updated estimates are received and/or as new/updated data is received via the data source(s) 106-116, to determine updated damage estimate scores 117 for an estimate based on the new/updated data.

After executing one or more estimate evaluation ML models 104 to determine various damage estimate scores 117 for an estimate, the damage estimate processor 118 may use the damage estimate scores 117 to determine various target downstream processes to initiate on various downstream target entities and/or systems. For instance, based on a set of accuracy and competitiveness scores for a damage estimate (e.g., above particular thresholds for both accuracy and competitiveness), the damage estimate processor 118 may automatically transmit instructions to the repair entity 120 (and/or additional systems) to cause the repair entity 120 to commence the vehicle repairs. As another example, when an estimate evaluation ML model 104 detects one or more errors, internal inconsistencies, or other unreliable data within a damage estimate (e.g., having an accuracy score below a threshold), the damage estimate processor 118 may automatically transmit a request (e.g., identifying the errors or inconsistencies) to the repair entity 120 to provide an updated damage estimate. In other examples, the damage estimate processor 118 may implement rules based on any combination of the outputs from the estimate evaluation ML model(s) 104 (e.g., predict repair cost outputs or ranges, predicted parts or service listings, accuracy thresholds or ranges, competitiveness thresholds or ranges, etc.) to identify outlier or potentially erroneous estimates. In these examples, when identifying an outlier or other estimate that may require further analysis and verification, the damage estimate processor 118 may transmit the estimate and related data (e.g., vehicle damage data, repair entity profile data, etc.) to a separate estimate analyzer 122 for a more comprehensive analysis. Based on the results of the additional analysis performed by the estimate analyzer 122 (which may be programmatic and/or manual), the estimate analyzer 122 may transmit instructions or requests to the repair entity 120, such as issuing repair orders, requests for corrections or additional data, etc.

Additionally, as shown in this example, the damage estimate processor 118 and/or the estimate analyzer 122 may update the repair entity profile data 116 repair entity that provided the estimate, based on the damage estimate scores 117 determined for the estimate. For example, the repair entity profile data 116 for a repair entity may include averages and/or distributions of estimate quality scores, accuracy scores, competitiveness scores, etc. The repair entity profile data 116 also may include other attributes associated with a repair entity, such as location, types of parts used, types of data provided on different estimate versions, and the like. Any or all of the repair entity profile data 116 for a repair entity 120 may be updated by the damage estimate processor 118 and/or the estimate analyzer 122, based on the output of the estimate evaluation ML models 104.

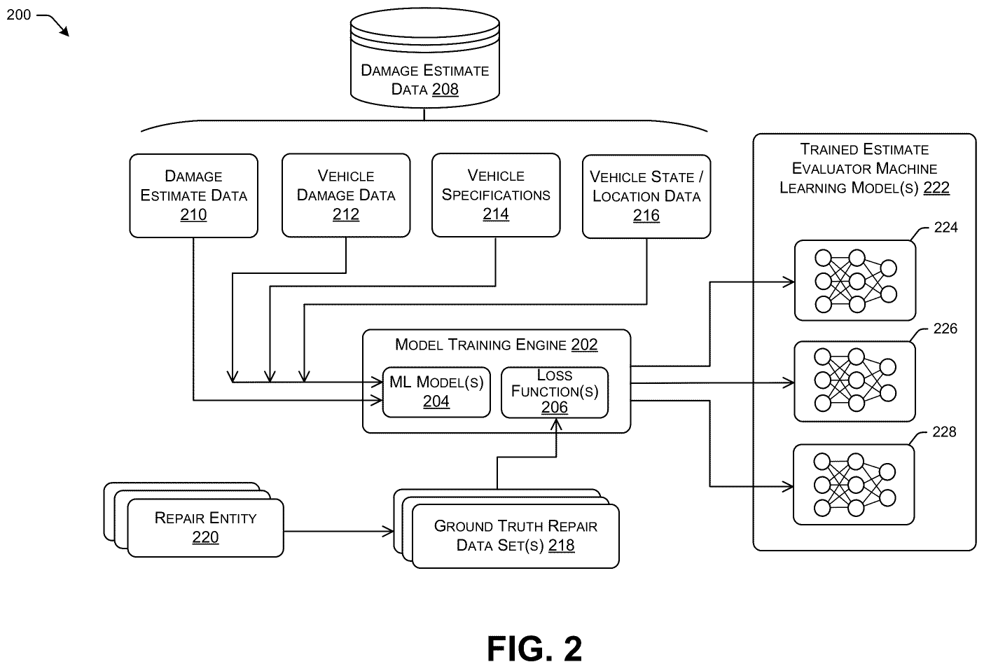

FIG. 2 depicts an example system 200 including a model training engine 202 configured to construct and train estimate evaluation ML model(s) 204, based on historical (or ground truth) data associated with previous damage estimates and corresponding repair data for actual repairs performed subsequent to the previous damage estimates. In some examples, the system 200 may use similar or identical components to those in system 100 discussed above, and the estimate evaluation ML model(s) 204 may be similar or identical to the estimate evaluation ML model(s) 104 discussed above. In other examples, the computing environment of system 100, including an estimate evaluator 102 configured to execute one or more estimate evaluation machine learning (ML) model(s) 104, may be different and separate from the computing environment of system 200, including the model training engine 202 and training data repositories. For instance, the model training engine 202, damage estimate data repository 208 and ground truth repair data set(s) 218 may be implemented within a cloud-based computing environment, while the estimate evaluator 102 and trained estimate evaluation ML model(s) 104 may operate in an on-premise data center associated with the vehicle owner, insurer, repair entity, etc.

The model training engine 202 may generate and train estimate evaluation ML models 204 based on various historical data associated with previous damage estimates and corresponding historical repair data. As shown in this example, the historical data used to train the estimate evaluation ML models 204 may include damage estimate data 210 representing previous estimates generated by one or more repair entities 220. Each record of the damage estimate data 210 may represent a previous damage estimate that may include similar or identical data to the damage estimate data 112 and/or any other examples of damage estimates described herein. For each previous damage estimate record, the model training engine 202 also may receive associated vehicle damage data 212 (e.g., the damage data that was available at the time the previous damage estimate was generated), vehicle specifications data 214 (e.g., the specifications of the vehicle for which the previous damage estimate was generated), vehicle state/location data 216 (e.g., the state and location of the vehicle for which the previous damage estimate was generated), etc. Additionally, the model training engine 202 may include ground truth repair data set(s) 218 representing the actual repairs subsequently performed on the vehicle by the repair entity 220, after the previous damage estimate 210 was generated.

Based on the damage estimate data 210, vehicle damage data 212, ground truth repair data set(s) 218 and/or other historical data associated with the damage estimate data 210, the model training engine 202 may use loss function(s) 206 to train one or more estimate evaluation ML models 204. The loss function(s) 206 may be used to evaluate the output of the in-training estimate evaluation ML models 204, including scoring the quality of the various outputs of the ML models 204 (e.g., accuracy scores, competitiveness scores, etc.) in view of the associated ground truth repair data set(s) 218 and/or other data associated with the historical damage estimate. Based on the scores (or costs) generated by the loss function(s) 206, the estimate evaluation ML models 204 may be trained in different ways (e.g., by minimizing loss) to output optimal predictions of the estimate accuracy scores, estimate competitiveness scores, etc.

In various examples, loss function(s) 206 may include any number of variables or criteria for training the estimate evaluation ML models 204 based on the ground truth repair data set(s) 218 and/or other input data. For example, a loss function 206 may determine a loss (cost value) based on the difference between the estimated cost in the damage estimate data 210 and the corresponding actual repair costs within the ground truth repair data set(s) 218. For instance, when there is a large difference between an estimated repair cost (from a ground truth damage estimate 210) and the subsequent actual repair cost (from the ground truth repair data 218), the estimate evaluation ML model 204 should be trained to output relatively lower accuracy scores. In contrast, for ground truth records having only minor differences between the estimated repair cost and the actual repair cost, the estimate evaluation ML model 204 should be trained to output relatively higher accuracy scores. Other loss functions 206 may determine losses to train the estimate evaluation ML models 204 based on the differences between parts and/or services listings with the damage estimate data 210 and the corresponding actual parts/services used in the repair within the ground truth repair data set(s) 218. In some examples, loss functions 206 can determine loss values for training the estimate evaluation ML models 204 based on errors or inconsistencies within the ground truth damage estimate data 210 (e.g., based on comparisons to the ground truth repair data set(s) 218 and/or other associated ground truth data), and/or based on repair entity attributes within the ground truth data.

The model training engine 202 can be used to implement and train estimate evaluation ML models 204 using various types of machine learning techniques and algorithms. For instance, the ML models 204 may include artificial neural network data structures having one or more levels, different node configurations, randomly assigned initial node weights, and the model training engine 202 may use one or more regression algorithms, instance-based algorithms, Bayesian algorithms, clustering algorithms artificial neural network algorithms, and/or deep learning algorithms, to train the ML models 204. Different ML models 204 (e.g., regression models, gradient models, etc.) also may implement different machine-learning algorithms including, but not limited to, regression algorithms (e.g., linear regression), instance-based algorithms, gradient descent algorithms, Bayesian algorithms, clustering algorithms, association rule learning algorithms, deep learning algorithms supervised learning, unsupervised learning, semi-supervised learning, etc.

In some examples, the model training engine 202 may generate and train a single ML model 204 to output estimate scores (e.g., quality scores, accuracy scores, competitiveness scores, etc.) based on a repository of broad and diverse ground truth estimate/repair data. In other examples, the model training engine 202 may generate and train multiple ML models 204 using different training data sets. As shown in this example, the model training engine 202 has generated a number of trained estimate evaluator ML models 222, including ML model 224, ML model 226, and ML model 228. In this example, the different ML models 224-228 may be based on different sets of training data corresponding to damage estimates for different types of vehicles, different geographic regions, different types of accidents/damage incidents, etc. In such examples, the model training engine 202 may generate and train multiple ML models 222 which can be applied by the estimate evaluator 102, which may select and execute an appropriate trained estimate evaluator ML model 222 based on the characteristics of the received estimate, vehicle, or repair entity, etc.

When training different estimate evaluator ML models 222, each ML model 222 may have an associated set of input data (or payload) determined by the model training engine 202. For instance, during the training process for an estimate evaluator ML model 204, the machine learning algorithms of the model training engine 202 may determine which estimate-related data is relevant (e.g., outcome determinative) for predicting repair costs, determining estimate accuracy scores, estimate competitiveness scores, etc. The relevant estimate-related data may be identified and used to determine the subsets of training data used to train the estimate evaluator ML models 222. Other estimate-related data may be determined by the model training engine 202 to be irrelevant (or less relevant) as a predictor for damage estimate scores, and this irrelevant (or less relevant) data may be excluded as input data from the trained ML models 222.

A data payload (or payload) may refer to the set of relevant estimate-related data provided as input to a trained ML model 222 (e.g., estimate evaluation ML models 104) configured to output damage estimate scores associated with an estimate received from a repair entity. As noted above, the estimate-related data may include data from an estimate, associated vehicle damage data, vehicle state/location/driving history data, repair entity data, etc. It can be understood that different estimate evaluation ML models 104 may use different combinations of estimate-related data as input, and thus may have different payloads. In some examples, the model training engine 202 may determine during training which ML models 222 to execute based on the characteristics of a received estimate, and may convey the selection criteria to the estimate evaluator 102. The estimate evaluator 102 may then compare the different payloads of the ML models 104 to the set of data that is currently available for an estimate. For instance, when an initial set of estimate-related data is received, the model estimate evaluator 102 may select and run a first ML model 104 (e.g., to generate a consistency or accuracy score for the estimate) for which the initial estimate-related data set satisfies the data payload. At a later time, when additional estimate-related data is received for the same estimate, the estimate evaluator 102 may select and run a second and more robust ML model 104 having a larger payload (e.g., to generate a competitiveness score for the estimate).

As noted above, different sets of training data (e.g., ground truth repair data set(s) 218) may be used to train different estimate evaluator ML models 224-228. In some examples, different sets of ground truth estimates and corresponding ground truth repair data 218 may be grouped based on the particular evaluation guidelines 114 used for the ground truth estimates and repairs. For instance, a first set of ground truth estimates and ground truth repair data 218 may include a subset of the ground truth estimates/vehicle repairs performed by repair entities complying with specific repair requirements (e.g., requirements regarding repair entity certifications, requirements regarding types of parts used in the repair, etc.). As an example, a first subset of the ground truth estimates and repair data may relate to estimates generated in compliance with a specific direct repair facility contract (e.g., specifying particular parts and/or services requirements, particular repair shop certification requirements, etc.). In this example, a different subset of the ground truth estimates and repair data may include estimates generated by certified dealerships relying solely on OEM guidelines and parts choices, etc. In these examples, when generating and training different estimate evaluator ML models 222, the model training engine 202 (and/or data scientists controlling the model training engine 202) may select different subsets of the ground truth estimates and ground truth repair data 218 when training the different ML models 222. Thus, when a first ML model 224 is trained using ground truth estimates/repair data corresponding to a specific set of repair requirements (e.g., repair facility contracts, certification requirements, repair and parts guidelines, etc.), the resulting trained ML model 224 may be used to determine damage estimate scores (and/or to predict damage estimate repair costs, parts and services lists, etc.) in situations when specific sets of evaluation guidelines apply to the estimate. In contrast, a different ML model 226 may be trained using different sets of ground truth estimates/repair data corresponding to a different set of repair requirements, and the resulting trained ML model 226 may be used to determine damage estimate scores in instances when that different set of evaluation guidelines apply. Thus, in these examples, the different ML models 224-228 may be applied in different situations to determine damage estimate scores based on the specific set of requirements (e.g., evaluation guidelines) that apply to the estimate.

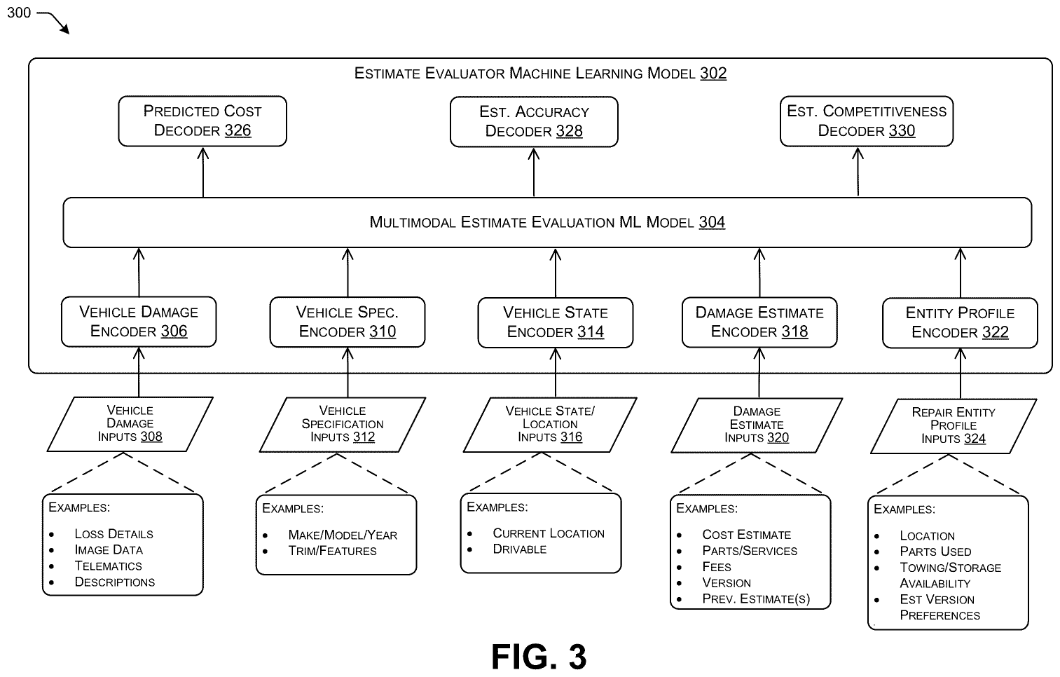

FIG. 3 depicts an example architecture 300 of a multimodal estimate evaluation ML model 302. As shown in this example, the ML model 302 may be configured to receive various types (or modalities) of data associated with a damage estimate to be evaluated. In this example, the outputs from the ML model 302 may include one or more of a predicted repair cost, an accuracy score for the estimate, and a competitiveness score for the estimate.

The multimodal estimate evaluation ML model 302 may be configured to receive multiple types (or modalities) of input data associated with a damage estimate. As shown in this example, the ML model 302 may include multiple encoders trained to receive and encode separate modalities of input data. For instance, the vehicle damage encoder 306 may be configured to encode vehicle damage input data 308. The vehicle damage input data 308 may include, for example, loss details associated with the vehicle accident or damage incident, images of the damaged portions of the vehicle, telematics data captured by the vehicle associated with the vehicle accident or damage incident, and/or text descriptions of the vehicle damage. The vehicle damage encoder 306, described in more detail below, may be trained to receive various types of vehicle damage input data 308 and encode the input data into fixed-sized embedding tokens (e.g., feature vectors in a predetermined vector space) representing the vehicle damage.

The vehicle specification encoder 310 may be configured to encode vehicle specifications input data 312 associated with the vehicle for which the estimate was provided. The specifications input data 312 may include, for example, the vehicle make, model, trim, year, and various vehicle features (e.g., two-wheel drive versus four-wheel drive versus all-wheel drive, etc.). The vehicle specification encoder 310 may be trained to receive various vehicle specifications input data 312 and encode the input data into fixed-sized embedding tokens representing the vehicle specifications.

The vehicle state encoder 314 may be configured to encode various vehicle state input data 316 associated with the vehicle for which the estimate was provided. The vehicle state input data 316 may include, for example, the current location of the vehicle (e.g., a tow yard, the owner's residence, etc.), whether or not the vehicle is currently drivable, the mileage of the vehicle, an/or the previous driving/accident history of the vehicle. The vehicle state encoder 314 may be trained to receive various vehicle state data 316 and encode the input data into fixed-sized embedding tokens representing the state of the vehicle.

The damage estimate encoder 318 may be configured to encode various damage estimate input data 320 associated with the damage estimate received from the repair entity. The damage estimate input data 320 may include, for example, the total repair cost indicated on the estimate, the listings of parts and/or services indicated on the estimate, any fees and/or taxes identified on the estimate, and/or the version of the estimate received from the repair entity. In some examples, the damage estimate input data 320 may include data related to previous estimate versions provided by the repair entity. The damage estimate encoder 318 may be trained to receive various damage estimate input data 320 and encode the input data into fixed-sized embedding tokens representing the damage estimate.

The entity profile encoder 322 may be configured to encode various repair entity profile input data 324 (e.g., entity attributes) associated with the repair entity that provided the damage estimate. The repair entity profile input data 324 may include, for example, the location (e.g., city, state, region, etc.) of the repair entity, the types of parts used by the repair entity (e.g., recycled parts, aftermarket parts, OEM parts, etc.), whether or not the repair entity provides towing or storage services, and/or different characteristics (e.g., patterns or preferences) that the repair entity has for different estimate versions. For example, a repair entity preference or characteristic may include whether or not the repair entity includes taxes and/or fees in various estimate versions, whether the repair entity provides initial estimates based on a visual inspection of the vehicle only and without a hands-on examination of the vehicle, etc. The entity profile encoder 322 may be trained to receive various repair entity profile input data 324 and encode the input data into fixed-sized embedding tokens representing the repair entity profile and attributes.

As in this example, when an estimate evaluation ML model 302 is trained to receive multimodal input data, the model may provide additional technical advantages over heuristics-based and/or ML-based estimate evaluation techniques that do not use multimodal input data. For example, a single-modality evaluation system might analyze and evaluate a damage estimate based only on the damage estimate itself. Such systems may, for example, learn to evaluate an estimate based on the parts and services listings on the estimate, the total repair costs in the estimate, and the like. However, single-modality systems that do not use vehicle damage data, repair entity data, vehicle state data, and the like, may be unable to learn to recognize the underlying assumptions used by the repair entities to generate the estimates, to verify (or evaluate the likelihood of) those assumptions using the multimodal data, or to detect various errors and/or internal inconsistencies in the estimates, etc. Thus, multimodal estimate evaluation ML models may be more accurate and robust than single-modality ML models.

However, implementing multimodal estimate evaluation ML models may present additional technical challenges for designing and training the ML models. Various model architectures may be used to design multimodal estimate evaluation ML models. In this example, the multimodal estimate evaluation ML model 302 uses a multilayer model architecture including a layer of modality-specific encoders which may be trained (individually or jointly) to output embedding tokens based on the modality-specific input data, and a multimodal estimate evaluation ML model 304 configured to receive the embedding tokens as input and to determine various damage estimate scores as output. In this example, the multimodal estimate evaluation ML model 304 may be trained to output a predicted repair cost (via a predicted cost decoder 326), an estimate accuracy score (via an estimate accuracy decoder 328), and an estimate competitiveness score (via an estimate competitiveness decoder 330). In other examples, the multimodal ML model 304 may be trained to output only one of these outputs, any two of these outputs, or any combination of these outputs and/or the additional estimate scores or evaluation data described herein.

In other examples, instead of using a multilayer architecture as shown in FIG. 3, a multimodal estimate evaluation ML model may be designed using a single layer (e.g., a single neural network structure) configured to receive multimodal input data at predetermined positions and predetermined token sizes into the model. For the various different ML model architectures described herein, including multilayer and single-layer architectures, each layer in the estimate evaluation ML model may include a set of transformer blocks or other neural network architectures such as least squares discriminator networks (LSDNs), recurrent neural networks (RNNs), VectorNets, and/or other fully-connected neural network architectures.

Multimodal estimate evaluation ML models, such as ML model 304, may be trained using training data that includes complete sets of multimodal input data, and/or may be trained with partial training data subsets in which one or more of the modalities is not present within the training data sets. For instance, the multimodal estimate evaluation ML model 304 can be trained to output estimate scores when all modalities are provided as input data (e.g., vehicle damage input data 308, vehicle specifications input data 312, vehicle state input data 316, damage estimate input data 320, and/or repair entity profile input data 324), but also may be trained to output estimate scores when one or more of the input data types is not provided to the model. As an example, during one model training operation, the training data may include vehicle damage input data 308, vehicle specifications input data 312, and damage estimate input data 320, but may mask (or exclude) vehicle state input data 316 or repair entity profile input data 324. In this example, the encoders not receiving input data may be configured to provide filler tokens to the multimodal estimate evaluation ML model 304 (e.g., zeroed-out embedding tokens, randomly generated embedding tokens, etc.), and the ML model 304 may learn to determine output estimate scores without the complete set of input data. Similar masking techniques may be used during model training by removing any combination of the input data. In some cases, the combination of encoders and/or the ML model 304 may be trained to accurately predict missing input data and/or the output from an encoder that did not receive input data (e.g., predicting accurate embedding tokens from the vehicle specification encoder 310 and/or predicting the vehicle specifications input data 312) based on the outputs from the other encoders that did receive input data.

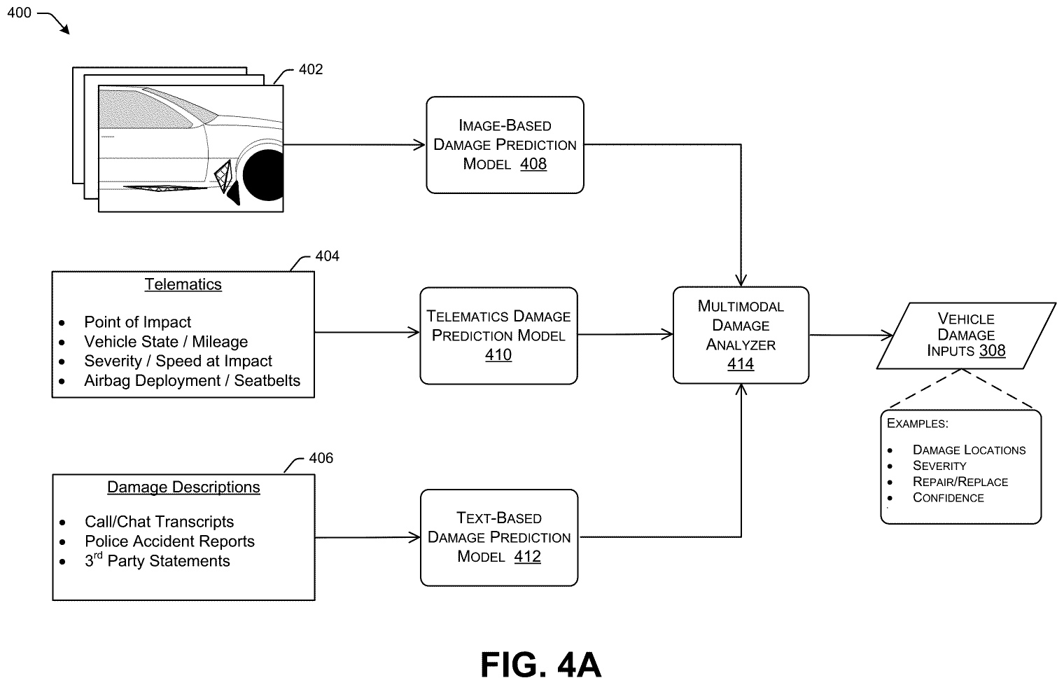

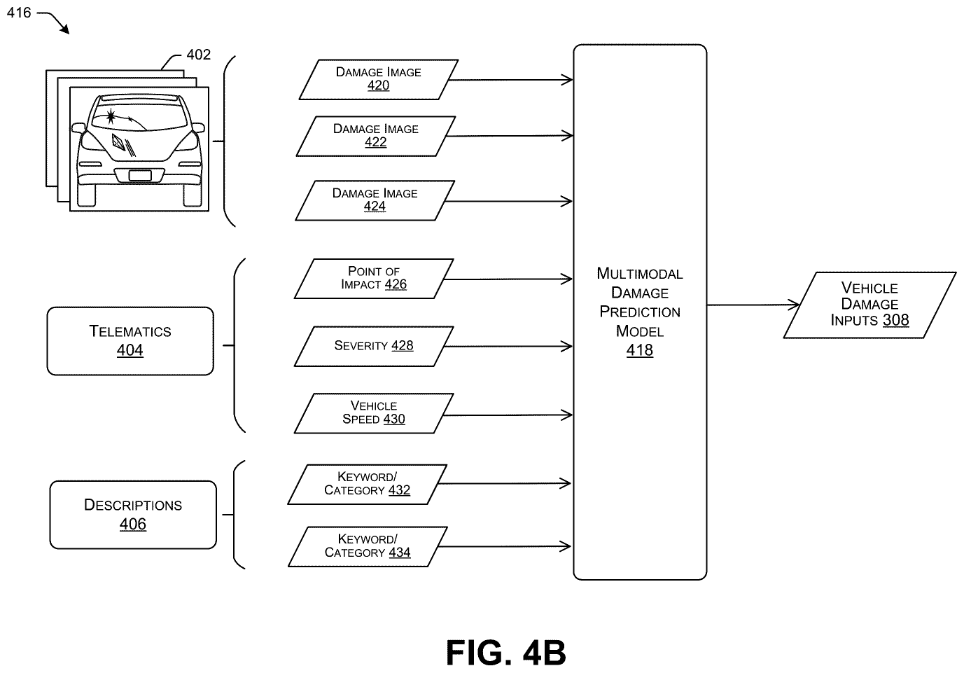

As discussed herein, in certain examples, an estimate evaluation ML model may be implemented as a multimodal ML model configured to receive different types (or modalities) of input data associated with a damage estimate. In some examples, separate ML components (e.g., encoders, transformers, neural networks, etc.) may be configured and trained specifically to receive, encode and/or output predictions based on one particular type/modality of input data. Additionally, each of the modality-specific components may include one or more ML components designed and trained to receive different data modalities. For example, referring now to FIGS. 4A and 4B, two example architectures are depicted for multimodal vehicle damage prediction ML models configured to output predictions of vehicle damage based on different types of damage-related input data.

FIG. 4A depicts a first example architecture for a multimodal vehicle damage prediction ML model 400 configured to receive multiple types/modalities of the input data, including images 402, telematics data 404, and damage description data 406. In this example, the ML model 400 includes a separate ML model for each of the modalities of vehicle damage data. The image-based damage prediction model 408 may be implemented via a transformer model, convolutional neural network (CNN), and/or other ML components. The image-based damage prediction model 408 may be trained to analyze vehicle images 402 and output damage predictions based on the images 402. In some examples, the image-based damage prediction model 408 may include one or more CNNs trained to perform image recognition techniques to identify dents in vehicle panels, dented fenders, broken signal lights, cracks in the windows/windshield, scraps to the body of the vehicle, frame damage, burn damage, fluid leaks, bent rims and axles, etc. In some examples, individual CNNs may be trained and deployed to detect individual types of damage based on the input images 402. Using these CNNs (and/or other ML-based components), the image-based damage prediction model 408 may output predicted vehicle damage data that indicates the likely damaged locations/parts on the vehicle, the severity of the damage, etc.

The telematics damage prediction model 410 may be implemented as a separate ML model(s) (and/or heuristics-based tools) configured and trained to analyze telematics data captured by the vehicle before, during, and after an accident or other damage incident, and output damage predictions based on the telematics 404. As shown in this example, telematics 404 may record information including a point of impact location, vehicle state data/mileage at the current time (and the time of an accident), the severity of the image and/or speed of the vehicle at the time of impact, whether or not the airbags were deployed during an accident, the number of passengers in the vehicle during an accident, whether the passengers were wearing seatbelts at the time of the accident, etc. Using one or more ML-based components (and/or heuristics-based components), the telematics damage prediction model 410 may receive the telematics 404 and output predicted vehicle damage data that indicates the likely damaged locations/parts on the vehicle, the severity of the damage, etc.

The text-based damage prediction model 412 may be implemented as a separate ML model(s) (and/or heuristics-based tools) configured and trained to analyze damage descriptions 406 of vehicle accidents and/or other vehicle damage incidents, and output damage predictions based on the damage descriptions 406. As shown in this example, the damage description data 406 may include text transcripts of calls, emails, videoconferences, chats, etc., in which a participant or witness to a vehicle accident may describe the accident (or other vehicle damage incident). Such descriptions may include references to speeds, directions of travel, trajectories, driving maneuvers, swerving or skidding, the severity of the impact, and the like. Using one or more trained ML-based components (and/or heuristics-based components), the text-based damage prediction model 412 may receive the damage descriptions 406 and output predicted vehicle damage data that indicates the likely damaged locations/parts on the vehicle, the severity of the damage, etc.

As noted above, each of the damage prediction models in this example (e.g., the image-based damage prediction model 408, the telematics damage prediction model 410, and the text-based damage prediction model 412) may be trained/configured to output similar predicted damage data for the vehicle. For instance, the output of any or all of these models may include listings of predicted damage locations on the vehicle (e.g., internal/external impact or damage locations on the vehicle, damaged panels, damaged parts, etc.), the predicted severity of the damage to each damaged location, and/or predictions regarding whether each damaged panel, part, or other component may need to be repaired or replaced. In some examples, one or more of the ML models and/or heuristics-based tools configured to analyze the vehicle damage data may output confidence levels associated with the predicted damage.

In this example, the predicted damage outputs of the image-based damage prediction model 408, the telematics damage prediction model 410, and the text-based damage prediction model 412 may be provided to the multimodal damage analyzer 414, which may aggregate and/or synchronize the different predicted damage data received from the separate models. The output of the multimodal damage analyzer 414 (which may correspond to the vehicle damage input data 308) may include a listing of predicted vehicle damage locations, associated predicted severities, and/or confidence levels associated with each damage location, etc. In some examples, the output of the multimodal damage analyzer 414 may include a multi-channel vehicle damage map based on the various vehicle damage prediction models. For instance, the multi-channel vehicle damage map may include a mapping of the vehicle (e.g., including external and/or internal components) identifying damage locations, severities, confidence levels, and/or other data representing the predicted damage to the vehicle.

FIG. 4B depicts a second example architecture for a multimodal vehicle damage prediction ML model 416 configured to receive multiple types/modalities of the input data. As in the previous example, the ML model 416 may be configured to receive multimodal input data including vehicle images 402, telematics data 404, and damage description data 406. In this example, the ML model 416 does not include separately trained ML models and/or heuristics to preprocess each of the modalities of vehicle damage data. Instead, in this example, the ML model 416 includes a single-layer architecture including a multimodal damage prediction model 418 configured to receive multimodal input data at predetermined positions and predetermined token sizes into the model. For example, the damage prediction model 418 may be configured to receive three damage images 420-424, which may have predetermined token sizes and may be provided to the model at predetermined positions. The damage prediction model 418 also may be configured to receive point of impact data 426, severity 428, and vehicle speed data 430 extracted from the vehicle telematics 404, and two keyword/category inputs 432-434 extracted from the damage description data 406.

Based on these inputs, the damage prediction model 418 may be trained to output vehicle damage input data 308, which may include a listing of predicted vehicle damage locations, associated predicted severities, and/or confidence levels associated with each damage location, etc. In various examples, the damage prediction model 418 may be trained to output predicted damage data estimate scores when all inputs 420-434 are provided to the model, or when one or more of the inputs 420-432 is not provided to the model. For example, when one or more of the inputs 420-432 is not available, the damage prediction model 418 may be executed with a null or filler token (e.g., zeroed-out data or random data). As described above, when the damage prediction model 418 is trained using masking techniques and filler tokens, the model may be trained to accurately predict vehicle damage input data 308 even when one or more of the inputs is not present.

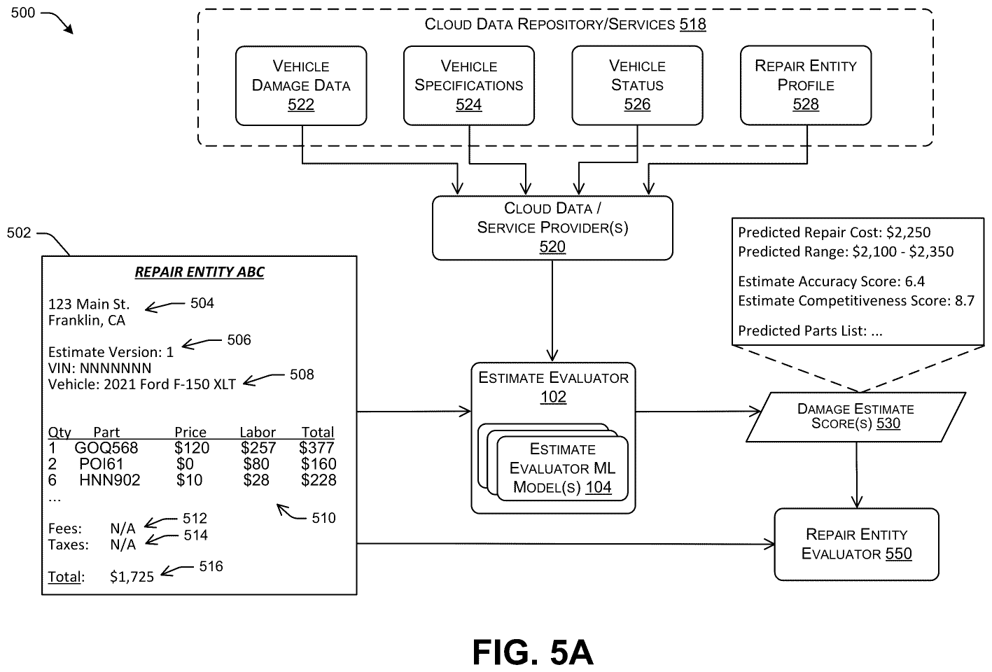

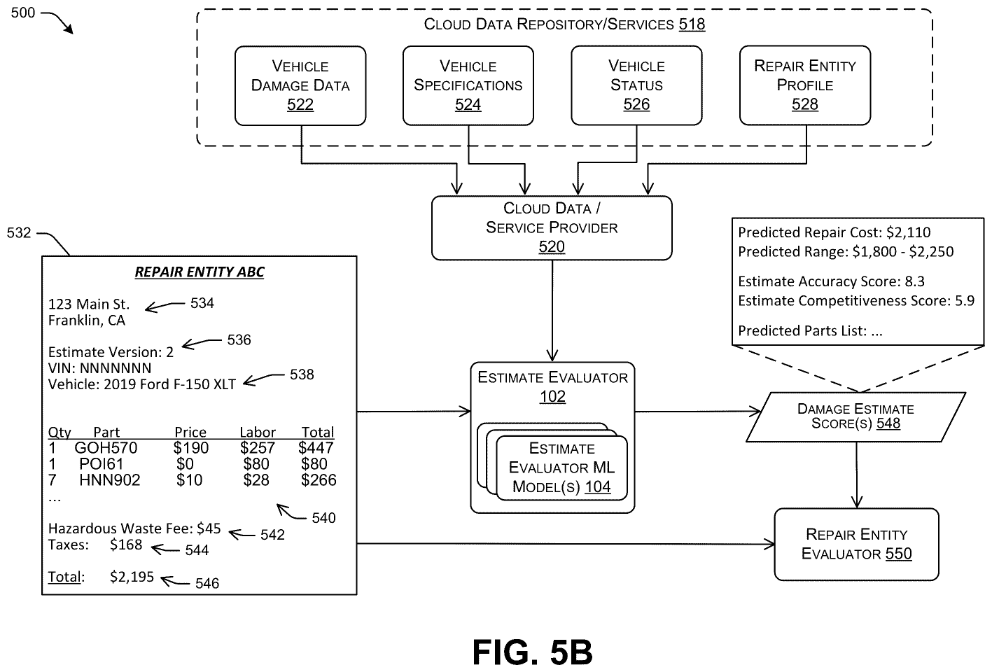

FIGS. 5A and 5B illustrate two examples of techniques of executing a trained estimate evaluation ML model to evaluate damage estimates received from a repair entity. In FIG. 5A, an example system 500 includes an estimate evaluator 102 configured to execute one or more trained estimate evaluation ML model(s) 104. A damage estimate 502 (which may be in physical or electronic form) may be generated by a repair entity and provided to the estimate evaluator 102 as a request to evaluate the damage estimate 502. As described herein, damage estimates may include various information relating to the repair entity that generated the estimate, the vehicle to which the estimate relates, and the proposed parts, services, fees, and the like indicated by the estimate 502. As shown in this example, the damage estimate 502 includes the name and address 504 of the repair entity that generated the estimate, the version 506 of the estimate, the vehicle identification number (VIN) and vehicle details 508 for the vehicle, an itemized listing of parts and services 510, a listing of fees 512, a listing of taxes 514, and an overall estimated repair cost 516.

In response to receiving the damage estimate 502, the estimate evaluator 102 may access various data sources to retrieve data related to the estimate 502, including data related to the vehicle, owner, repair entity, etc. In this example, one or more of the data sources may be stored and/or deployed within cloud data repositories and/or services 518, which the estimate evaluator 102 may access via one or more cloud data/service providers 520, as described herein. To access the data and/or services from any of the cloud-based data sources in this example, the estimate evaluator 102 may determine and transmit cloud service calls via the cloud service providers 520. Such service calls may include software instructions using a declarative configuration language in a structured format. To generate and access cloud-based data services, estimate evaluator 102 may use languages including one or more of Terraform® by Hashicorp®, Cloudformation® by AWS®, Azure Resource Manager® by Microsoft Azure®, Cloud Deployment Manager® by Google®, Oracle Orchestration Cloud® by Oracle®, or Ansible® by Redhat®. It can be understood from this disclosure that these structured format languages are non-limiting examples only, and that any other domain-specific language for provisioning and access cloud-based services and data repositories may be used in other examples. Further, in other examples, any or all of the data sources accessed by the estimate evaluator 102 may include local data stores, on-premise services, etc.

In this example, a vehicle damage data service/repository 522, a vehicle specifications data service/repository 524, a vehicle status data service/repository 526, and a repair entity data service/repository 528 may be deployed or stored within the cloud data repositories and/or services 518. These data stores and/or services may correspond to the various data sources 106-116 described above in FIG. 1, and may store and provide access to any or all of the vehicle-related, damage-related, estimate-related, and/or repair-entity-related data described herein.

Requests from the estimate evaluator 102 to the various services/repositories 522-528 may include requests to retrieve data specifically related to the vehicle identified in the damage estimate 502, the repair entity that generated the damage estimate 502, and/or the accident/incident for which the estimate was generated. Using the data retrieved from the various services/repositories 522-528, the estimate evaluator 102 may select and execute one or more of the estimate evaluator ML model(s) 104 to determine damage estimate score(s) 530 associated with the damage estimate 502. As shown in this example, the damage estimate score(s) 530 output by the estimate evaluator ML model(s) 104 may include (but are not limited to) any combination of a predicted repair cost, predicted repair cost range, predicted parts listings, predicted service listings, overall estimate quality score, estimate accuracy score, estimate competitiveness score, etc.

As described herein, the estimate evaluator ML model(s) 104 may be trained to use the data from the damage estimate 502 and the associated input data from the services/repositories 522-528, to determine the various underlying assumptions relied-on by the repair entity when generating the damage estimate 502, analyzing the reasonableness of those underlying assumptions, and outputting damage estimate score(s) 530 based on these analyses and taking into account repair entity-specific information. For instance, the estimate score(s) 530 determined by the estimate evaluator ML model(s) 104 may be based on analyses such as whether the vehicle details identified in the estimate 502 are compatible with the vehicle specifications received from the service/repository 524, whether the parts and services identified in the estimate 502 are compatible with the vehicle specifications received from the service/repository 524, whether the parts and services identified in the estimate 502 are compatible with each other, whether the parts and services identified in the estimate 502 are likely accurate based on the vehicle damage data received from the service/repository 522, whether the parts and services identified in the estimate 502 are compatible with the practices and patterns of the repair entity profile data received from the service/repository 528, whether the services and fees in the estimate are compatible with the current state and location of the vehicle received from the service/repository 526 (e.g., including towing charges a drivable vehicle or vehicle at the repair entity shop, failing to include towing charges for a non-drivable vehicle elsewhere, etc.), whether the services and fees in the estimate are compatible with the repair entity location and services (e.g., failing to include the proper hazardous waste disposal fees, etc.). In addition to these examples, various other estimate evaluator ML model(s) 104 may be trained to output estimate scores for quality, accuracy, competitiveness, and the like, based on any combination of these factors (e.g., using loss functions during training) and/or any other estimate factors or analyses described herein.

In FIG. 5B, the estimate evaluator 102 is depicted receiving an updated second version of a damage estimate 532, retrieving additional estimate-related data from the data services/repositories 522-528 (if needed), and re-executing the estimate evaluator ML model(s) 104 to determine updated damage estimate scores 548 for the updated damage estimate 532. As noted above, repair entities may provide different versions of a damage estimate at different times within the evaluation and repair process. For instance, a repair entity may provide a first estimate version based on an initial set of available data and/or assumptions regarding the extent of the damage to the vehicle, etc., and may provide an updated version of the estimate after subsequently analyzing the vehicle damage and/or beginning the repairs, including updated parts/services, updated costs, fees and taxes, etc. In some examples, updated versions of damage estimates may be requested by the estimator evaluator 102 (e.g., damage estimate processor 118). For instance, after executing the estimate evaluator ML model(s) 104 on an initial version of a damage estimate, the estimate quality scores, accuracy scores, and/or other outputs from the ML models 104 may indicate likely errors or inconsistencies within the initial estimate version. In these cases, the damage estimate processor 118 may automatically transmit a request for an updated estimate version (e.g., including the accuracy score and/or identifications of specific errors/inconsistencies) to the repair entity.

In this example, the repair entity has provided an updated damage estimate (e.g., correcting errors in the previous version and/or based on additional analysis of the vehicle damage, etc.). As with the initial version of the damage estimate 502, the updated damage estimate 532 also includes the name and address 534 of the repair entity, the updated estimate version 536, the updated VIN and vehicle details 538, an updated itemized listing of parts and services 540, an updated listing of fees 542, an updated listing of taxes 544, and an updated overall estimated repair cost 546. In response to receiving the updated damage estimate 532, the estimate evaluator 102 may perform similar operations of retrieving updated estimate-related data from the various services/repositories 522-528, if needed, and re-executing the ML models 104 to determine updated damage estimate scores 548 associated with the updated damage estimate 532. As shown in this example, the accuracy score of the updated damage estimate 532 is increased from the initial version of the damage estimate 502 (e.g., indicating that the estimate is more accurate and closer to a final damage repair estimate), but the competitiveness score of the updated estimate has decreased (e.g., indicating that the repair entity's final damage repair estimate might not be as competitive relative to other repair entities as indicated by the initial damage estimate).

In some examples, the system 500 also may include a repair entity evaluator 550. The repair entity evaluator 550 may be integrated into the estimate evaluator 102, or may be implemented separately as shown in this example. The repair entity evaluator 550 may be configured to receive damage estimate(s) 502 generated by the various repair entities, as well as the corresponding damage estimate score(s) 530 determined for the damage estimate(s) 502 by the estimate evaluator 102. Based on the damage estimates and corresponding estimate scores for one or more repair entities, the repair entity evaluator 550 may determine various scores (or indexes) for each repair entity, such as a repair entity estimate quality index, estimate accuracy index, estimate competitiveness index, etc. As described herein, repair entity indexes may be calculated using various statistical techniques, and may be determined independently of and/or relative to the repair entity indexes of other repair entities. For example, a set of repair entity indexes for a particular repair entity may be calculated as individual score values (e.g., mean or median scores for estimate accuracy, competitiveness, etc.) and/or may be calculated as distributions (e.g., an accuracy distribution, a competitiveness distribution, etc.).

Additionally, in some examples, the estimate evaluator 102 and/or the repair entity evaluator 550 may include one or more user interfaces (e.g., client application-based tools, web browser-based services or applications, etc.). For instance, an estimate evaluator 102 and/or a repair entity evaluator 550 may be accessed via a front-end dashboard view displayed via an intranet site or client tool operating within an internal organization network. When a user interface is provided to access the estimate evaluator 102 and/or the repair entity evaluator 550, the user interface may be configured to allow users to retrieve, select, and/or upload estimates 502 for evaluation, and to allow users to visualize the damage estimate scores determined for the selected estimates. Damage estimate score(s) 530 output via the dashboard view or other user interface (e.g., an overall quality score, an accuracy score, a competitiveness score, a repair cost score, etc.) may be displayed as score values within ranges of values (e.g., a showing maximum and minimum values) and/or may be displayed within distributions of values. The dashboard view may use these and/or other data display techniques (e.g., color coding, sizing, highlighting values above/below a threshold, etc.) to allow the user to easily visualize the evaluation of the estimate relative to other estimates performed the same repair entity, and/or other estimates performed by other repair entities. The dashboard view also may allow users to select particular repair entities and to display the current indexes for the repair entities (e.g., repair entity estimate quality indexes, estimate accuracy indexes, estimate competitiveness indexes, etc.). In some examples, the dashboard view also may also users to visualize the repair entity indexes relative to other repair entities (e.g., using ranges, percentiles, graphs, distributions, etc.), and/or to visualize the current trends or patterns of the repair entity indexes (e.g., by comparing the current and previous indexes of the repair entity).

Both for estimate scores and repair entity indexes, the dashboard view (or other user interface) also may include features (e.g., user interface controls) to allow users to filter the score and index data by vehicle type, repair entity type, geographic location, estimate version, time period, and the like. For instance, by applying filters in the dashboard view to a set of repair entity indexes, the user may easily visualize various indexes of the repair entity (e.g., a shop accuracy index and/or a competitiveness index) for the repair entity as a whole, or with respect to particular subsets of estimates provided by the repair entity (e.g., estimate competitiveness for particular types of vehicles, estimate competitiveness within a particular geographic region, etc.).

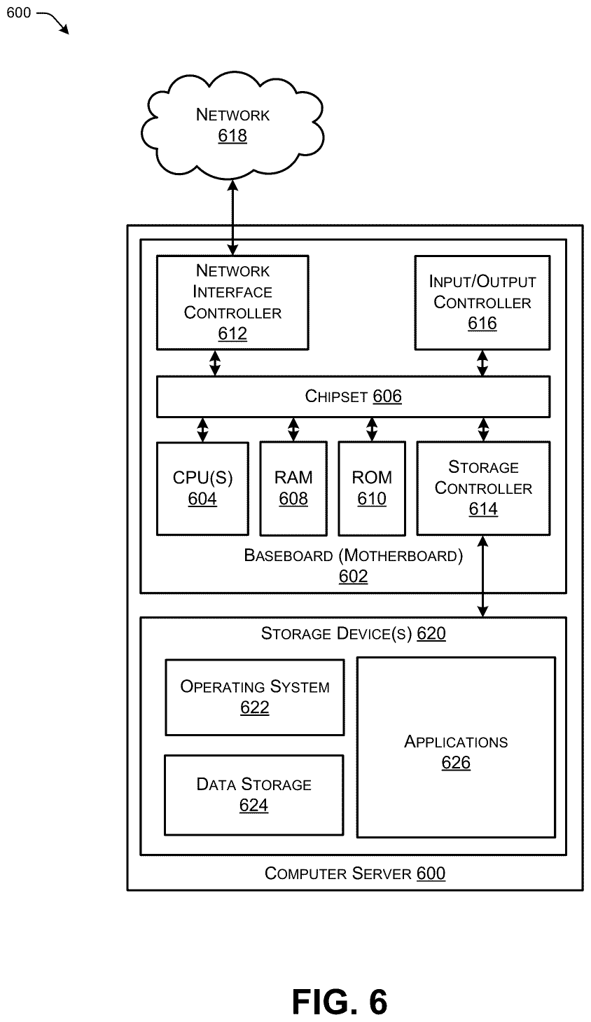

FIG. 6 shows an example computer architecture for a computer server 600 capable of executing program components for implementing the functionality described herein. The computer architecture shown in FIG. 6 may correspond to the systems and components of a server computer, workstation, desktop computer, laptop, tablet, network appliance, mobile device (e.g., tablet computer, smartphone, etc.), or other computing device, and can execute any of the software components described herein. The computer server 600 may, in some examples, correspond to any of the computing systems or devices described above, such as an estimate evaluator 102, damage estimate processor 118, estimate analyzer 122, repair entity 120, model training engine 202, and/or any other components within or associated with systems for training, deploying, and executing machine learning models to evaluate damage estimates received from repair entities. It will be appreciated that in various examples described herein, a computer server 600 might not include all of the components shown in FIG. 6, can include additional components that are not explicitly shown in FIG. 6, and/or may utilize a different architecture from that shown in FIG. 6.

The computer server 600 includes a baseboard 602, or “motherboard,” which may be a printed circuit board to which a multitude of components or devices are connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer server 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer server 600. The chipset 606 can further provide an interface to a computer-readable storage medium such as a ROM 610 or non-volatile RAM (“NVRAM”) for storing basic routines that help to startup the computer server 600 and to transfer information between the various components and devices. The ROM 610 or NVRAM can also store other software components necessary for the operation of the computer server 600 in accordance with the configurations described herein.

The computer server 600 can operate in a networked environment using logical connections to remote computing devices and computer systems through a network, such as the network 618, which may be similar or identical to communication network(s) discussed above. The chipset 606 also may include functionality for providing network connectivity through a Network Interface Controller (NIC) 612, such as a gigabit Ethernet adapter. The NIC 612 is capable of connecting the computer server 600 to other computing devices over the network 618. It should be appreciated that multiple NICs 612 can be present in the computer server 600, connecting the computer to other types of networks and remote computer systems. In some instances, the NICs 612 may include at least on ingress port and/or at least one egress port.

The computer server 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device.

The computer server 600 can include one or more storage device(s) 620, which may be connected to and/or integrated within the computer server 600, that provide non-volatile storage for the computer server 600. The storage device(s) 620 can store an operating system 622, data storage systems 624, and/or applications 626, which are described in more detail herein. The storage device(s) 620 can be connected to the computer server 600 through a storage controller 614 connected to the chipset 606. The storage device(s) 620 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer server 600 can store data on the storage device(s) 620 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 620 are characterized as primary or secondary storage, and the like.

For example, the computer server 600 can store information to the storage device(s) 620 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer server 600 can further read information from the storage device(s) 620 by detecting the physical states or characteristics of one or more particular locations within the physical storage units.

In addition to the storage device(s) 620 described above, the computer server 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer server 600. In some examples, the various operations performed by a computing system (e.g., estimate evaluator 102, model training engine 202, etc.) may be supported by one or more devices similar to computer server 600. Stated otherwise, some or all of the operations described herein may be performed by one or more computers server 600 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device(s) 620 can store an operating system 622 utilized to control the operation of the computer server 600. In some examples, the operating system 622 comprises a LINUX operating system. In other examples, the operating system 622 comprises a WINDOWS® SERVER operating system from MICROSOFT Corporation of Redmond, Washington. In further examples, the operating system 622 can comprise a UNIX operating system or one of its variants. It should be appreciated that other operating systems can also be utilized. The storage device(s) 620 can store other system or application programs and data utilized by the computer server 600.

In various examples, the storage device(s) 620 or other computer-readable storage media is encoded with computer-executable instructions which, when loaded into the computer server 600, transform the computer from a general-purpose computing system into a special-purpose computer capable of implementing various techniques described herein. These computer-executable instructions transform the computer server 600 by specifying how the CPUs 604 transition between states, as described above. In some examples, the computer server 600 may have access to computer-readable storage media storing computer-executable instructions which, when executed by the computer server 600, perform the various techniques described herein. The computer server 600 can also include computer-readable storage media having instructions stored thereupon for performing any of the other computer-implemented operations described herein.

As illustrated in FIG. 6, the storage device(s) 620 may store one or more data storage systems 624 configured to store data structures and other data objects. Additionally, the software applications 626 stored on the computer server 600 may include one or more client applications, services, and/or other software components. For example, application(s) 626 may include any combination of the components in the system 100 and/or system 200, and/or any or all of the various other software components described above in reference to FIGS. 1-5.

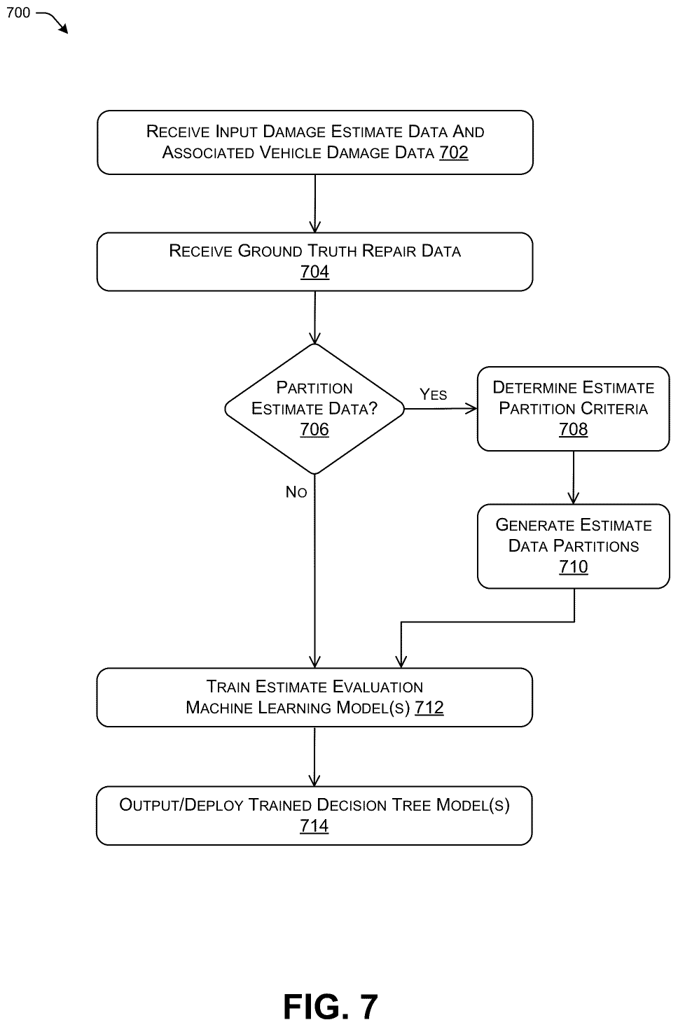

FIG. 7 is a flow diagram illustrating an example process 700 of training one or more estimate evaluation ML models to output scores (and/or other output data) associated with damage estimates received from repair entities. In various examples, some or all of the operations of process 700 may be performed by a model training engine 202 including repositories of historical damage estimate records and corresponding vehicle repair ground truth data. As described below, the model training engine 202 may use combinations of previous estimate records, associated estimate-related data, and ground truth repair data to train one or more ML models 104 to determine various estimate scores (and/or other outputs) for damage estimates. A model training engine 202 may be implemented within various computing environments including damage estimate records from repair entities, law enforcement organizations, insurance companies, and the like, as depicted in FIG. 2, or may be implemented within a separate server and/or computing environment. In various examples, the model training engine 202, and/or the data sources/repositories from which the ground truth training data is received, may be implemented in a public, private, or hybrid cloud in a cloud computing environment, or may be implemented in an on-premise data center.

At operation 702, the model training engine 202 may receive historical damage estimate data associated with one or more previous damage estimates generated by one or more repair entities. In some examples, the model training engine 202 may receive the historical estimate data along with additional estimate-related data from one or more of the data sources 210-216. Examples of ground truth estimate data may include statements, reports, and/or other information provided by the parties or witnesses to an accident. Examples of additional estimate-related data associated with a previous damage estimate may include additional sources of vehicle damage data that were available at the time of the estimate, the vehicle specifications, the vehicle state data and/or location at the time of the estimate, the vehicle driving history at the time of the estimate, repair entity profile data at the time of the estimate, etc.).

At operation 704, the model training engine 202 may receive ground truth vehicle repair data associated with the same set of previous damage estimates that were received in operation 702. As discussed above, ground truth vehicle repair data may include records from repair entities and/or other data sources (e.g., law enforcement, insurance data sources, etc.) indicating the confirmed and actual damages associated with the previous damage estimates and the actual repairs performed (e.g., final parts listings, final services listings, final repair costs, final fees, etc).

At operation 706, the model training engine 202 may determine whether the historical damage estimate data and corresponding ground truth repair data, received in operations 702 and 704 respectively, are to be partitioned into multiple training data sets. In some examples, the model training engine 202 may use a single training data set to train a single ML model 104 for determining estimate scores based on various estimate-related input data. In such examples, the model training engine 202 may determine not to partition the historical estimate data and ground truth repair data into multiple data sets (706: No).

However, in other examples, the model training engine 202 may use multiple different sets of training data and may train multiple ML models 104. In these examples, each of the ML models 104 can be associated with one or more classifications of estimates, for instance, based on location, vehicle type, accident type, repair type, etc. For instance, a first ML model 104 can be trained to score estimates involving a particular vehicle class, and a different ML model 104 can be trained to score estimates involving different vehicle classes. As another example, a first ML model 104 can be trained to score estimates in a particular state/region and for particular types of accidents/vehicle damage, while different ML models 104 can be trained to score estimates for different types of accidents occurring in different states/regions, etc. In these examples, the model training engine 202 may determine that the historical accident data and ground truth data are to be partitioned into multiple data sets (706: Yes). Accordingly, at operation 708, the model training engine 202 may determine one or more criteria for partitioning the historical estimate data, estimate-related data, and ground truth injury data. Examples of criteria may include any combination of estimate attributes, repair entity attributes, vehicle attributes, accident-related attributes, etc. Then, at operation 710, the model training engine 202 may generate the estimate data partitions and partition the data into multiple separate training data sets, each of which may be used to train a separate ML model 104.

At operation 712, the model training engine 202 may train one or more ML models 104 based on the training data sets determined in operations 706 and/or 710. In various examples, the model training engine 202 may construct and train ML models using various machine learning techniques and algorithms, including (but not limited to) neural network-based ML models, regression algorithms, instance-based algorithms, gradient descent algorithms, decision tree algorithms, Bayesian algorithms, clustering algorithms, association rule learning algorithms, deep learning algorithms supervised learning, unsupervised learning, semi-supervised learning, etc. As described above, in some examples, the ML models 104 generated and trained by the model training engine 202 may include multimodal ML models that may be configured to receive different types of input data. In some cases, multimodal ML models may use single-layer or multilayer architectures, and may include separate ML components (e.g., transformer blocks, CNNs, etc.) trained to receive and encode/infer based on separate modalities of input data.

At operation 714, the model training engine 202 may output and/or store the ML model(s) 104 generated and trained in operation 712. The ML model(s) 104 may be stored in a server (or other computer storage) associated with an estimate evaluator 102. In some cases, model training engine 202 may operate in one computing environment (e.g., a cloud-based environment) to receive estimate-related data and train the models, and may provide the trained models to an estimate evaluator 102 computer system operating in a separate computing environment (e.g., an on-premise datacenter) for execution. In some cases, the model training engine 202 also may determine payload information associated with the trained ML model(s) 104, and may output the payload information to the systems associated with the estimate evaluator 102. As noted above, different data payloads associated with different ML models 104 may include different set of estimate-related data to be provided as input to the ML models 104.

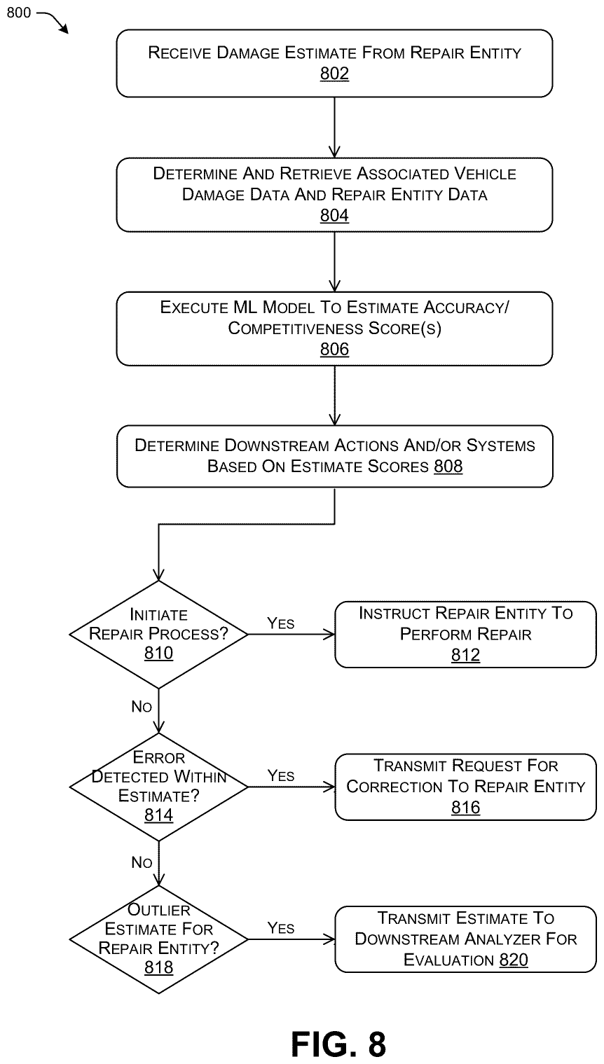

FIG. 8 is a flow diagram illustrating a process 800 of selecting and executing a trained ML model 104 configured to determine and output estimate score(s) based on damage estimate received from a repair entity, using the model outputs (e.g., accuracy and competitiveness) to determine and initiate processes on one or more target systems. In various examples, some or all of the operations of process 800 may be performed by an estimate evaluator 102 including one or more ML models 104. As described herein, the estimate evaluator 102 may be implemented within various computing environments including damage estimate records from repair entities, law enforcement organizations, insurance companies, and the like, as depicted in FIG. 1, or may be implemented within a separate server and/or computing environment. In various examples, the estimate evaluator 102 and/or the data sources/repositories from which the data associated with an estimate to be evaluated are received, may be implemented in a public, private, or hybrid cloud in a cloud computing environment, or may be implemented in an on-premise data center.

At operation 802, the estimate evaluator 102 may receive data associated with a damage estimate generated for a vehicle (or multiple vehicles) by a repair entity. In various examples, the estimate and estimate-related data received in operation 802 may be an initial estimate from a repair entity, or may be an updated estimate based on a previous estimate generated by the repair entity. Examples of estimate data that may be received in 802 can include repair entity identifier data, parts listings, service listings, estimated repair costs, vehicle data, location data, fees data, etc.

At operation 804, the estimate evaluator 102 may determine and retrieve various estimate-related data associated with the damage estimated received in operation 802. For example, in response to receiving a damage estimate in operation 802, the estimate evaluator 102 may analyze the damage estimate to retrieve various estimate-related attributes, and then may access data sources to retrieve additional data related to the estimate. Such additional estimate-related data may include vehicle damage from a vehicle damage service or repository, vehicle specifications data, current vehicle status and location data, repair entity profile data and/or attributes, etc.

At operation 806, using the estimate data received in operation 802, and the estimate-related data retrieved from the various data sources (e.g., services, repositories, etc.) in operation 804, the estimate evaluator 102 may select and execute one or more estimate evaluator ML model(s) 104 to determine damage estimate score(s) for the damage estimate. As described herein or more estimate evaluator ML model(s) 104 may be trained to output various damage estimate score(s) including estimate quality scores, estimate accuracy scores, estimate competitiveness scores, and the like. In some examples, the estimate evaluator ML model(s) 104 may be trained to output the various damage estimate score(s) using loss functions that teach the ML model(s) 104 to recognize the underlying assumptions used by the repair entities to generate the estimates, to verify (or evaluate the likelihood of) those assumptions using the multimodal data, or to detect various errors and/or internal inconsistencies in the estimates, and the like.

At operation 808, the estimate evaluator 102 (and/or a related damage estimate processor 118) may use the damage estimate score(s) output by the estimate evaluator ML model(s) 104 to determine various downstream systems to invoke and/or actions to perform based on the damage estimate score(s). For instance, at operation 810, the damage estimate processor 118 may evaluate the damage estimate scores for the estimate to determine whether or not to automatically initiate the repair of the vehicle by the repair entity. In an example, when the damage estimate processor 118 determines that the accuracy score and the competitiveness score for the damage estimate are greater than respective threshold values (810: Yes), then at operation 812 damage estimate processor 118 may automatically instruct the repair entity to commence the vehicle repairs based on the damage estimate.

As another example, at operation 814, the damage estimate processor 118 may evaluate the damage estimate scores to determine whether or not the estimate likely includes errors or inconsistencies that can be remedied by the repair entity. For instance, at operation 814 (which may be performed prior to or instead of operation 810 in some examples), the damage estimate processor 118 may evaluate the damage estimate scores for the estimate to determine whether or not to automatically request a corrected/updated estimate from the repair entity. In an example, when the damage estimate processor 118 determines that the accuracy score for the damage estimate is lower than an accuracy threshold value (814: Yes), then at operation 816 damage estimate processor 118 may automatically request a corrected/updated estimate from the repair entity.

As another example, at operation 818, the damage estimate processor 118 may evaluate the damage estimate scores to determine whether or not the estimate is an outlier (e.g., overall or with respect to the repair entity) that may require further analysis from one or more downstream analysis systems. For instance, at operation 818 (which may be performed prior to or instead of operation 810 and/or operation 814 in some examples), the damage estimate processor 118 may evaluate the damage estimate scores for the estimate to determine whether or not to flag the estimate and/or transmit the estimate to a downstream estimate analyzer system for further analysis. In an example, when the damage estimate processor 118 determines that the combination of the accuracy score and/or competitiveness score for the damage estimate (and/or other estimate data) meets various outlier threshold values (818: Yes), then at operation 820 damage estimate processor 118 may automatically transmit the estimate and associated estimate-related data to a downstream analyzer system for further analysis and evaluation.

Thus, the techniques for training, deploying, and executing machine learning models to evaluate damage estimates received from repair entities may provide various technical advantages in evaluating damage estimates from repair entities. For instance, the ML model training techniques described herein provide improved accuracy and efficiency over existing systems for determining whether an estimate received from a repair entity is accurate and/or competitive. Unlike existing systems, the ML-based techniques described herein may learn to reliably predict the level of quality of damage estimates, including by learning the underlying assumptions relied on by the repair entity when generating the estimate, verifying the reasonableness of the underlying assumptions (e.g., based on the multimodal vehicle damage data), and taking into account repair entity-specific attributes based on profiles. These systems and techniques also provide improved and more efficient operations with respect to obtaining new or updated estimates, automatically analyzing outlier estimates, and/or initiating vehicle repairs. As described herein, these techniques also may improve the functioning and efficiency of computer systems that use ML models within estimate evaluation systems, including using an event-driven system to automatically trigger execution of an estimate evaluation ML model in response to receiving an estimate from a repair entity, automatically executing (or re-executing) the ML model based on receiving updated vehicle damage data from one or more data sources, and/or initiating requests to repair entities for updated or corrected estimates based on the analysis of the ML model.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer system, comprising:
a processor; and
memory storing computer-executable instructions that, when executed by the processor, cause the computer system to perform operations comprising:
receiving damage data associated with a vehicle, the damage data including at least one of:
image data of the vehicle; or
telematics data associated with the vehicle;
receiving a damage estimate determined by a repair entity, the damage estimate associated with the vehicle;
providing the damage data and the damage estimate as input to a multimodal machine learning model configured to receive:
a first encoding based on the image data;
a second encoding based on the telematics data; and
a third encoding based on a vehicle specification of the vehicle, the multimodal machine learning model generating an output based on the damage data and the damage estimate;
determining a damage estimate score based on the output of the multimodal machine learning model; and
instructing a downstream system to process the damage estimate, based on the damage estimate score.

2. The computer system of claim 1, the operations further comprising:
providing the image data as input to an image-based damage prediction model;
determining, based on an output of the image-based damage prediction model, at least one of:
a part identifier associated with a potentially damaged part on the vehicle;
a severity value of a potentially damaged part on the vehicle; or
a confidence value associated with a potentially damaged part damaged part on the vehicle.

3. The computer system of claim 1, wherein the input to the multimodal machine learning model further comprises at least one of:
a listing of parts associated with the damage estimate; and
a listing of expenses associated with the damage estimate.

4. The computer system of claim 1, wherein the damage estimate comprises a current version of the damage estimate determined by the repair entity, and wherein the input to the multimodal machine learning model is indicative of at least one of:
an entity attribute associated with the repair entity;
a version number associated with the current version of the damage estimate; or
a previous damage estimate from a previous version of the damage estimate determined by the repair entity.

5. The computer system of claim 1, the operations further comprising:
determining, based on the damage estimate score, an entity score associated with the repair entity.

6. The computer system of claim 1, wherein instructing the downstream system is further based on an entity score associated with the repair entity.

7. The computer system of claim 1, wherein the output of the multimodal machine learning model comprises at least one of:
a predicted repair cost associated with the damage estimate;
a range of predicted repair costs associated with the damage estimate;
an accuracy score associated with the damage estimate; or
a competitiveness score associated with the damage estimate.

8. The computer system of claim 1, wherein instructing the downstream system comprises at least one of:
providing the damage estimate to an estimate analysis process for processing;
transmitting a request for updated to the damage estimate to a system associated with the repair entity; or
initiating an automated process to instruct the repair entity to repair the vehicle, based on the damage estimate score.

9. A computer-implemented method, comprising:
receiving damage data associated with a vehicle;
receiving damage estimate data associated with the vehicle, for a damage estimate determined by a repair entity;
providing the damage data and the damage estimate data as input to a machine learning model;
determining, based on an output of the machine learning model, a score associated with the damage estimate; and
based on the score associated with the damage estimate, transmitting instructions to cause the repair entity to initiate a repair process on the vehicle.

10. The computer-implemented method of claim 9, wherein the damage data includes image data of the vehicle, and wherein the method further comprises:
providing the image data as input to a second machine learning model;
determining, based on an output of the second machine learning model, a part identifier associated with a potentially damaged part on the vehicle, a severity value of the potentially damaged part, and a confidence value of the potentially damaged part; and
providing the part identifier, the severity value, and the confidence value as input to the machine learning model.

11. The computer-implemented method of claim 9, wherein the input to the machine learning model comprises:
a first input based on an image of vehicle damage within the damage data;
a second input based on telematics data from the vehicle; and
a third input based on a vehicle specification of the vehicle.

12. The computer-implemented method of claim 9, wherein the input to the machine learning model comprises:
an input based on a listing of parts associated with the damage estimate; and
an input based on a listing of expenses associated with the damage estimate.

13. The computer-implemented method of claim 9, wherein the damage estimate comprises a current version of the damage estimate determined by the repair entity, and wherein the input to the machine learning model comprises at least one of:
an input based on an entity attribute associated with the repair entity;
an input based on a version number associated with the current version of the damage estimate; or
an input based on previous damage estimate data from a previous version of the damage estimate determined by the repair entity.

14. The computer-implemented method of claim 9, further comprising:
determining, based on the score associated with the damage estimate, an entity score associated with the repair entity.

15. The computer-implemented method of claim 9, wherein transmitting the instructions to cause the repair entity to initiate the repair process on the vehicle is further based on an entity score associated with the repair entity.

16. The computer-implemented method of claim 9, wherein the output of the machine learning model comprises at least one of:
a predicted repair cost associated with the repair process;
a range of predicted repair costs associated with the repair process;
an accuracy score associated with the damage estimate; or
a competitiveness score associated with the damage estimate.

17. One or more non-transitory computer-readable media storing instructions executable by a processor, wherein the instructions, when executed by the processor, cause the processor to perform operations comprising:
receiving damage data associated with a vehicle;
receiving damage estimate data associated with the vehicle, for a damage estimate determined by a repair entity;
providing the damage data and the damage estimate data as input to a multimodal machine learning model;
determining, based on an output of the multimodal machine learning model, a damage estimate score associated with the damage estimate; and
processing the damage estimate using a downstream system, based on the damage estimate score.

18. The one or more non-transitory computer-readable media of claim 17, wherein the damage data includes image data of the vehicle, and wherein the operations further comprise:
providing the image data as input to an image-based damage prediction model;
determining, based on an output of the image-based damage prediction model, a part identifier associated with a potentially damaged part on the vehicle, a severity value of the potentially damaged part, and a confidence value of the potentially damaged part; and
providing the part identifier, the severity value, and the confidence value as input to the multimodal machine learning model.

19. The one or more non-transitory computer-readable media of claim 17, wherein the input to the multimodal machine learning model comprises:
a first input based on an image of vehicle damage within the damage data;
a second input based on telematics data from the vehicle; and
a third input based on a vehicle specification of the vehicle.

20. The one or more non-transitory computer-readable media of claim 17, wherein processing the damage estimate is further based on an entity score associated with the repair entity.
